(19) United States
(12) Patent Application Publication
(10) Pub. No.: US 2022/0331795 A1
(43) Pub. Date: Oct. 20, 2022

(54) MODIFIED LUER FITTINGS AND IMPROVED SOLID PHASE EXTRACTION SYSTEM

(71) Applicant: Kevin Charles DINNEAN, Webster, NH (US)

(72) Inventor: Kevin Charles DINNEAN, Webster, NH (US)

(21) Appl. No.: 17/721,944

(22) Filed: Apr. 15, 2022

Related U.S. Application Data
(60) Provisional application No. 63/175,328, filed on Apr. 15, 2021.
(60) Provisional application No. 63/243,202, filed on Sep. 13, 2021.

(51) Int. Cl. B01L 3/00; B01D 15/22; B01D 11/02

(52) U.S. Cl. CPC B01L 3/502715; B01D 15/22; B01D 11/0219; B01L 3/563; B01L 2200/0689

(57) ABSTRACT

A Luer lock includes a tapered female member and a tapered male member defining a passage. A tubing is inserted through the passage. The tubing defines an outer cross-section corresponding to an inner cross-section of the passage. The tapered male member is configured to be inserted into the tapered female member such that the tube is in fluid communication with the tapered female member, and the tubing exerts a compressive force at a mating surface between the tapered male member and the tapered female member to increase friction therebetween and inhibit leakage. The male member may define a side port defined on a side wall thereof. The side port may provide an additional fluid pathway for application of vacuum or pressure through the tapered male member.

### CROSS-REFERENCE TO RELATED APPLICATIONS

This application claims priority to and the benefit of U.S. Provisional Patent Application No. 63/175,328, filed Apr. 15, 2021 and titled “Modified Luer Fittings and Solid Phase Extraction System,” and U.S. Provisional Patent Application No. 63/243,202, filed Sep. 13, 2021 and titled “Modified Luer Fittings and Improved Solid Phase Extraction System,” the disclosures of which are hereby incorporated by reference in its entirety.

### TECHNICAL FIELD

Embodiments described herein relate to Luer fittings and Solid Phase Extraction systems including such Luer fittings.

### BACKGROUND

Solid phase extraction (SPE) involves removing minor chemical constituents from a sample of water or other liquid. This is generally done for two purposes. The first of these two purposes is to capture the method analytes (the chemicals a given SPE procedure seeks to isolate) on an SPE disk for the purpose of identifying the specific chemicals present and determining their concentration in the original water or other liquid sample. The second of these two purposes is to remove or isolate the chemical constituents that are not analytes of the testing procedure being employed. These chemical constituents are removed because they can interfere with the accurate identification or quantification of the method analytes. The chemical identity and concentration of the chemical constituents removed as interferents by the solid phase extraction process are not determined. It is possible for a procedure to employ both processes described. An SPE procedure is usually followed by a determinative technique to identify the specific chemical identity and concentration of the method analytes. These determinative techniques include gas chromatography, liquid chromatography, mass spectrometry, and optical (or light absorption) techniques. There is a need for improved systems to improve solid phase extraction and reduce costs thereof.

### SUMMARY

In some embodiments, a Luer lock includes a tapered female member and a tapered male member defining a passage. A tubing is inserted through the passage. The tubing defines an outer cross-section corresponding to an inner cross-section of the passage. The tapered male member is configured to be inserted into the tapered female member such that the tube is in fluid communication with the tapered female member, and the tubing exerts a compressive force at a mating surface between the tapered male member and the tapered female member to increase friction therebetween and inhibit leakage.

In some embodiments, a Luer lock includes a tapered female member, and a tapered male member defining a central axis and passage along a central axis. A side port is defined through a sidewall of the tapered male member, the side port defining a lateral passage. A tubing is inserted through the passage along the central axis, the tubing defining an outer cross-section corresponding to an inner cross-section of the passage. The tapered male member is configured to be inserted into the tapered female member such that the tube is in fluid communication with the tapered female member.

In some embodiments, a disk holder for Solid Phase Extraction (SPE) includes a cylindrical cavity with a closed bottom including an angled section, a first recess having a first diameter and a first thickness, a second recess defining a second diameter and a second thickness and an opening. A SPE disk and a porous member is disposed in the cavity. A male Luer fitting is disposed on a Luer valve, the male Luer fitting installed in the opening. The porous member has a diameter equal to the second diameter and a thickness equal to the second thickness. The SPE disk has a thickness equal to the first diameter and a thickness equal to the first thickness.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a cross-section view of an unmodified male Luer lock fitting.

FIG. 2 is a cross-section view of a male Luer lock fitting having a passage through the center of the Luer port that is enlarged to accept a tubing, according to an embodiment.

FIG. 3 is a cross-section view of a modified male Luer lock fitting with a tubing passing through the center of the Luer port, according to an embodiment.

FIG. 4 is a cross-section view of a modified male Luer lock fitting with a tubing passing through the center of the Luer port and side port disposed through one of the hex flats, according to an embodiment.

FIG. 5 is a cross-section view of a female Luer fitting, according to an embodiment.

FIG. 6 is a cross-section view of an unmodified Luer plug fitting.

FIG. 7 is a cross-section view of a Luer plug fitting modified by having the passage through the center of the Luer port being enlarged to accept a tubing, according to an embodiment.

FIG. 8 is a cross-section view of a modified Luer plug fitting with a tubing passing through the center of the Luer port, according to an embodiment.

FIG. 9 is a cross-section view of an unmodified female Luer lock fitting, according to an embodiment.

FIG. 10 is a cross-section view of a modified female Luer lock fitting with a side port disposed through one of the hex flats, according to an embodiment.

FIG. 11 is a cross-section view of a modified Luer plug fitting with a tubing passing through the center of the Luer port and a female Luer lock fitting with a line showing how these two fittings interface, according to an embodiment.

FIG. 12 is a cross-section view of a female Luer fitting, a modified male Luer lock fitting with a tubing passing through the center of the Luer port and a side port drilled through one of the hex flats, according to an embodiment.

FIG. 13 is a cross-section view of a solid phase extraction (SPE) system fluid management block and a vial, according to an embodiment.

FIG. 14 is a cross-section view of a solid phase extraction system fluid management block and associated fittings, set screw, vial cap, PTFE washer, a tubing and a vial, according to an embodiment.

FIG. 15A is a cross-section view of a solid phase extraction system disk holder with SPE disk, porous member, male Luer fitting and a male×female Luer 2 port valve, according to an embodiment.

FIG. 15B is a cross-section view of a solid phase extraction system disk, according to an embodiment.

FIG. 15C is a cross-section view of a solid phase extraction system disk, according to an embodiment.

FIG. 16 is a cross-section view of a bottle holder and valve assembly, according to an embodiment.

FIG. 17 is a perspective view of a SPE system rack for holding system components during use, according to an embodiment.

FIG. 18 is a perspective view of a SPE system rack for holding system components during use with individual upper shelf segments, according to an embodiment.

FIG. 19 is a top view of the upper shelf of the SPE system rack, according to an embodiment.

FIG. 20 is a top view of an individual upper shelf segment of the SPE system rack, according to an embodiment.

FIG. 21 is a cross-section view of a SPE system fluid management block having an opening for mounting the block on a rack and a vial, according to an embodiment.

FIG. 22 is a cross-section view of a SPE system fluid management block and associated fittings, set screw, vial cap, PTFE washer, a tubing, an opening for mounting the block on a rack and a vial, according to an embodiment.

FIG. 22A is a cross section of a female Luer barb fitting with wing grips, according to an embodiment.

FIG. 22B is a cross section of a modified female Luer barb fitting with wing grips, according to an embodiment.

FIG. 23 is a perspective view of an example of a SPE system rack with hinged support leaves and detachable support leaves for holding the bottle holder and valve assembly and other system components during use, according to an embodiment.

FIG. 23A is a cross section view of a hinged support leaf for use on the system rack depicted in FIG. 23, according to an embodiment.

FIG. 23B is a cross section view of a detachable support leaf for use on the system rack depicted in FIG. 23, according to an embodiment.

FIG. 24 is a perspective view of an example of a SPE system rack with hinged support leaves and detachable support leaves for holding the bottle holder and valve assembly and other system components during use, according to an embodiment.

FIG. 24A is a cross-section view of a hinged support leaf for use on the system rack depicted in FIG. 24, according to an embodiment.

FIG. 24B is a cross-section view of a detachable support leaf for use on the system rack depicted in FIG. 24, according to an embodiment.

FIG. 25 is a perspective view of an example of a SPE system rack with detachable support leaves and a horizontal member having attachment points at two levels for holding the bottle holder and valve assembly and other system components during use, according to an embodiment.

FIG. 25A is a cross-section view of a detachable support leaf for use on the system rack depicted in FIG. 25, according to an embodiment.

FIG. 26 is an exterior perspective view of a SPE cartridge, according to an embodiment.

FIG. 26A is a cross-section view of an example of a SPE cartridge, according to an embodiment.

FIG. 27 is a perspective view of an example of a SPE system rack with detachable support forks and a horizontal member having attachment points at two levels for holding the bottle holder and valve assembly and other system components during use, according to an embodiment.

FIG. 27A is a perspective view of a detachable support fork, according to an embodiment.

FIG. 27B is a cross-section view of a detachable support fork, horizontal member and associated parts, according to an embodiment.

FIG. 27C is a cross-section view of a fluid management block connected in series with a SPE cartridge, according to an embodiment.

### DETAILED DESCRIPTION

An SPE procedure is usually followed by a determinative technique to identify the specific chemical identity and concentration of the method analytes. These determinative techniques include gas chromatography, liquid chromatography, mass spectrometry, and optical (or light absorption) techniques. SPE disks are often used to perform the SPE procedure. The SPE disks are filters used to remove chemicals from liquids as part of a SPE procedure. These SPE disks generally contain one or more sorbents embedded in a glass fiber matrix. This glass fiber matrix forms the structure of the SPE disk. Sorbents may consist of particles of silica with or without surface modifications, or particles of polymeric material that have hydrophobic, hydrophilic or ion exchange functionality. Both the sorbent particles and the glass fiber matrix adsorb chemical constituents (analytes and interferents) from liquid samples passed through the SPE disk. A filtration apparatus is employed to filter the sample through the SPE disk. The filtration device may consist of a bottom piece on which the SPE disk rests and a funnel, or reservoir, that attaches to the bottom piece while also securing the SPE disk in place. The bottom piece needs to incorporate a mesh, porous member or other type of permeable member to allow liquids to pass through the disk, generally aided by vacuum, in a uniform manner. A means to collect the liquids that pass through the disk is also necessary. A variety of filtration apparatuses are available, from simple manually operated systems to complex automated systems.

A SPE disk, after installation in a filtration device, may first be rinsed with a suitable solvent to remove impurities that may be present in the SPE disk with the solvent being removed from the SPE disk, under vacuum (or forced through the SPE disk under positive pressure). This solvent is collected and usually discarded.

Certain SPE disks need to be preconditioned in order to function properly. An example of an SPE procedure using an SPE disk requiring preconditioning would be a procedure employing an SPE disk containing a C-18 sorbent being used to test drinking water for chemical contaminants. C-18 sorbent consists of particles of silica or polymer with an octadecyl surface modification imparting hydrophobic properties. If using a C-18 disk, after any rinsing with solvent to remove impurities as previously described, the SPE disk is rinsed with methyl alcohol to precondition the C-18 sorbent. The methyl alcohol is partially pulled through the SPE disk displacing any prior rinse solvents but is not completely pulled through the disk exposing the C-18 sorbent to air. After this conditioning with methyl alcohol, the SPE disk must remain immersed in methyl alcohol or water until the sample filtration step is complete. Next, water is added to the reservoir diluting the methyl alcohol covering the top of the disk. The water is partially pulled through the disk, substantially displacing the methyl alcohol but again leaving a layer of water on top of the disk to avoid exposing the C-18 sorbent to air. Next, the water sample undergoing analysis is added to the reservoir and vacuum applied under the disk to facilitate filtering the water sample through the SPE disk. As the water sample passes through the SPE disk, chemicals such as pesticides or herbicides present in the water sample are retained by adsorption onto the C-18 sorbent or adsorption onto the glass fiber structural material of the SPE disk. After the filtration of the water sample is complete, air is generally passed through the disk, aided by the continued application of vacuum, for a short time to remove residual water.

If it is desired to first remove impurities that may have been retained by the SPE disk that could interfere with the identification and quantification of method analytes using the intended determinative technique, then the following procedures are employed. A suitable rinse solution such as an aqueous salt solution or a polar organic solvent may be added to the reservoir. An organic solvent, if used, would need to be a polar solvent as a strongly non-polar organic solvent would not mix with or displace the residual water left in the disk. The non-polar organic solvent may also fail to pass through the disk under vacuum due to the immiscibility of water and the strongly non-polar organic solvent. Care must be exercised in choosing a rinse solvent as the rinse solvent must remove the impurities without removing the analytes filtered out of the original water sample. This rinse solvent is normally discarded.

The next step is to transfer the analytes removed from the water sample by the SPE disk to a suitable solvent. This step is necessary prior to conducting a determinative analysis to identify the chemical composition and concentration of the analytes that were present in the original water sample. First, a small volume of a polar organic solvent, such as acetone or ethyl acetate, is added to the reservoir and soaks through the disk. This polar elution solvent serves two purposes: it helps remove any remaining water, and it begins the process of transferring the chemicals removed from the original water sample to organic solvent. This first solvent rinse, or elution solvent, is removed under vacuum and collected in a clean container. This may be followed by adding a small volume of a non-polar solvent to the reservoir as necessary to remove certain hydrophobic analytes that are more strongly retained by the SPE disk. This solvent is also removed under vacuum and collected, usually in the same container as the first polar elution solvent. This step may be repeated several times as necessary depending on the specific procedure being employed. When the necessary or proscribed elution procedure has been completed, it is often necessary to remove any water from this collected elution solvent (or extract) before proceeding. This can be done by passing the solvent extract through an anhydrous salt such as sodium sulfate.

This dried solvent extract can undergo a variety of determinative techniques to identify and determine the concentration of the analytes present in the solvent extract. These determinative techniques include gas chromatography, liquid chromatography, mass spectrometry, and optical (or light absorption) techniques. This information from the determinative technique on the concentration of analytes in the extract can be used to calculate the concentration of the analytes in the original water sample. These calculations would also require the volume of the original water sample and the final volume of the solvent extract, both of which should be determined. The extract may also be partially evaporated from a volume of, for example, 20 mL to a volume of 0.5 mL prior to analysis by the determinative technique, provided the extract solvents are sufficiently volatile. For example, a 40-fold reduction in volume would increase the concentration of analytes in the extract by up to 40 times. This increase in the concentration of analytes in the extract results in the determinative technique being able to detect the method analytes at a 40-fold lower concentration. Method analytes may be partially lost during the evaporation step if the boiling points of the extract solvents are not significantly lower than the boiling point of a given method analyte. Alternately, if the method analytes are sufficiently non-volatile, the extract may be evaporated to dryness and reconstituted in a solvent appropriate for the intended determinative technique. It is also possible to evaporate the solvent to dryness and determine the concentration of material extracted from the original water sample by weighing the residue left after the evaporation is complete. This weighing, or gravimetric technique, does not identify the specific chemicals that were present in the original water sample.

Luer Lock fittings are commonly used in SPE for fluid communication across various components and steps. Luer Lock fittings are commonplace not just in SPE but also in medical applications and many others. For example, Luer lock fittings may be utilized within intravascular or hypodermic applications of medical devices/instrumentation (such as needles, syringes, catheters, and infusion sets) to facilitate a leak-free or substantially leak-free administration of various fluids to a patient through a central line, eliminating the need for multiple needle insertions within a given patient. As used herein, the term “leak-free” or “substantially leak-free” implies that there is less than 0.01% of leakage of a fluid form a sealing interface of two surfaces that are in contact with one another.

Luer fittings are categorized as Luer slip and Luer lock connectors. A Luer slip fitting consists of a tapered male member that slips onto its mating tapered cavity of a female member and relies on compression forces and resulting friction between the mated surfaces to achieve a leak-free connection. Accidental separation can happen in Luer slip connections when the connection is inadvertently pulled. To mitigate accidental separation, Luer-lock fittings are used which have integrated locking threads in addition to the components of a Luer Slip fitting. In a Luer lock fitting, when the male and female parts are screwed together, the surfaces are compressed in the same manner as the Luer slip; however, due to the threaded coupling, the connection cannot be simply pulled apart. Owing to their simplicity, Luer slip fittings are typically used in low-pressure applications while threaded Luer lock fittings are use in applications where more robust and secure connections are needed. As described herein, there is an incentive to deploy Luer connections with better fluid communication under higher pressure and/or during the use of more aggressive solvents that may leak through conventional Luer fittings. In addition, there may be further benefits of a more secure connection in a Luer Slip design without the use of a threaded skirt as used in the Luer Lock fitting.

Embodiments of the various Luer lock fittings described herein and systems including such Luer lock fittings may provide one or more benefits, including, for example: 1) providing a tighter fit between a male Luer lock and a female Luer lock by providing a tube through an enlarged passageway of the male Luer lock so as to increase a compressive force on the corresponding female Luer lock and inhibiting leakage; 2) providing a side port in male and/or female Luer locks so as to enable application of a vacuum or pressure through the male and/or female Luer lock; 4) allowing modification of existing Luer locks to obtain a better fit; 4) providing simple shelving systems and manual operation thus, reducing capital and operational cost; 5) being equally applicable in various fields including analytical chemistry, water filtration, water sampling, etc.

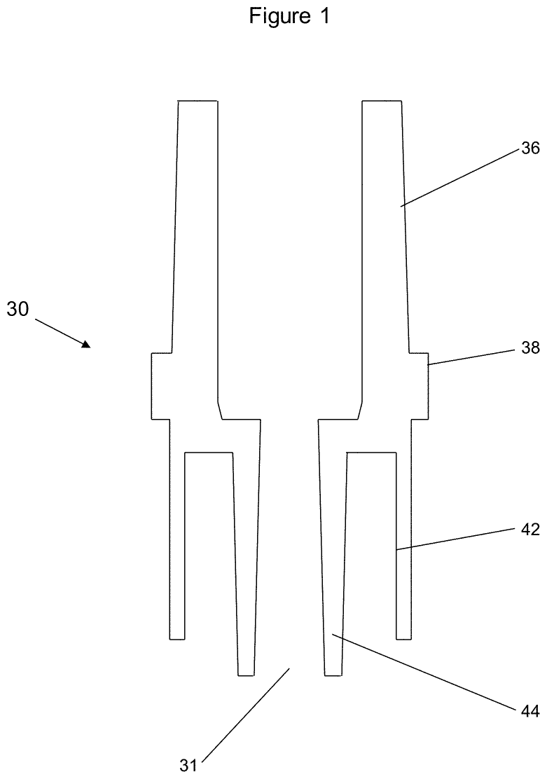

FIG. 1 shows the cross section of an unmodified male Luer lock fitting 30, according to an embodiment. The male Luer lock fitting 30 (for example, a male ⅛ NPT×male Luer lock fitting) may include male pipe thread 36 (for example, ⅛ NPT pipe thread) with hex flats 38 present to allow fitting 30 to be installed into a female opening such as a female threaded opening (for example, a ⅛ NPT threaded opening) with an open end wrench or similar tool. Luer lock thread 42 (actual thread is not shown) is at the other end of the fitting and accepts female Luer lock 54. Male Luer tip or port 44, in use, interfaces with female Luer port 54 to create a leak free connection. A passageway 31 is defined through the center of Luer port 44 and is tapered such that the upper opening of the Luer port 44 is wider than the lower opening of the Luer port 44. In some embodiments the angle of taper is in a range of about 1° to about 10°, for example, about 6°.

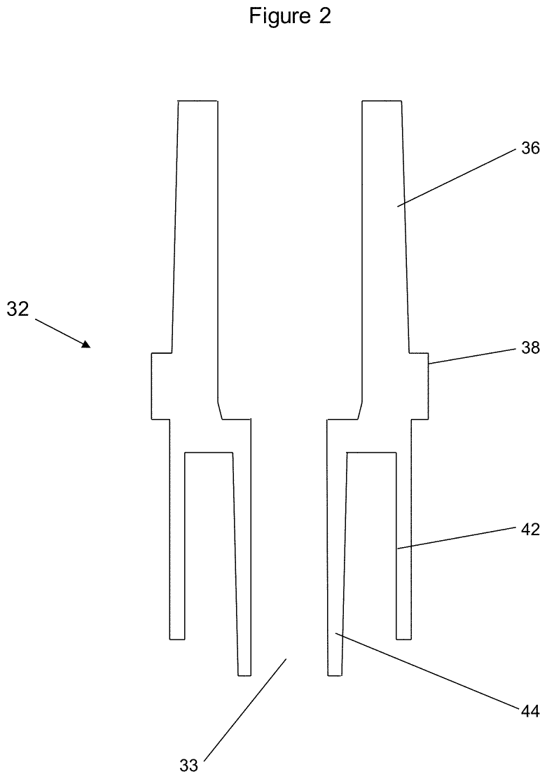

FIG. 2 shows the cross section of a male Luer lock fitting 32, according to an embodiment. The male Luer lock fitting 32 (for example, a ⅛ NPT×male Luer lock fitting) defines a passageway 33 drilled through the center of male Luer tip or port 44 such that the passageway 33 is enlarged relative to the passageway 31 of the Luer lock fitting 30 (i.e., has a larger cross-sectional width or diameter than the passageway 31) to allow insertion of a tubing 46 (for example, with of ⅛″ outside diameter) therethrough. Male pipe thread 36 (for example, ⅛ NPT pipe thread) is shown with hex flats 38 present to allow fitting 30 to be installed into a female threaded opening (for example with ⅛ NPT threaded opening) with an open end wrench or similar tool. Luer lock thread 42 (actual thread is not shown) is at the other end of the fitting and accepts female Luer lock 54. male Luer tip or port 44, in use, interfaces with female Luer port 54 to create a leak free connection. In some embodiments, the enlarged passageway 33 through the male Luer port 44 may be formed during manufacturing of the male Luer lock 32, for example, during an injection molding process. In some embodiments, the inner wall of the passageway 33 is substantially parallel. In other words, the passageway 33 may have a taper of less than 0.01° from an upstream to a downstream end thereof such that passageway 33 may define a substantially constant cross-sectional width (e.g., diameter) from the upstream to the downstream end thereof. In some embodiments, the inner wall of the passageway 33 has a taper, the angle of the taper is in a range of about 0.01° to about 10° (e.g., about 6°).

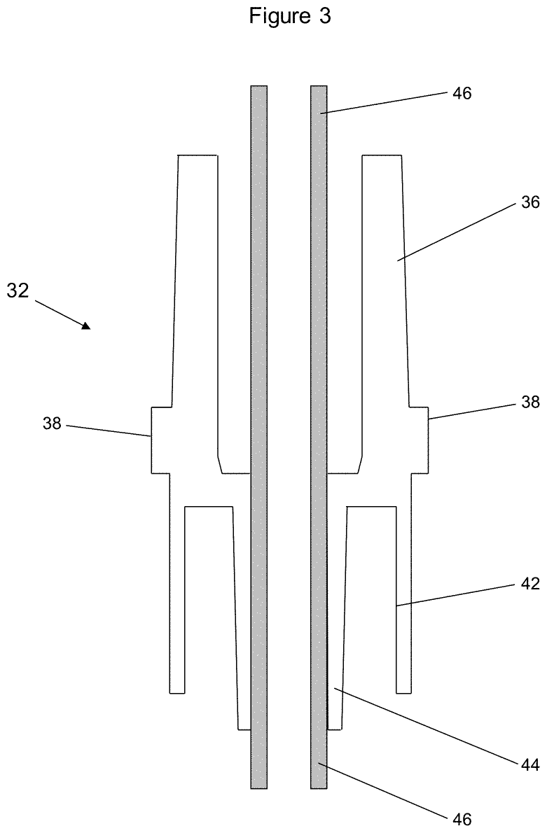

FIG. 3 shows a cross section of the modified male Luer lock fitting 32 with a tubing inserted through the passageway 33 defined therethrough, according to an embodiment. The tubing 46 is shown passing through passageway 33 of port 44. A pipe thread 36 (for example, male ⅛ NPT pipe thread) is shown with hex flats 38 present to allow fitting 30 to be installed into a female ⅛ NPT threaded opening with an open end wrench or similar tool. Luer lock thread 42 (actual thread is not shown) is at the other end of the fitting and accepts female Luer lock 54. Male Luer tip or port 44, in use, may interface with female Luer port 54 to create a leak free connection.

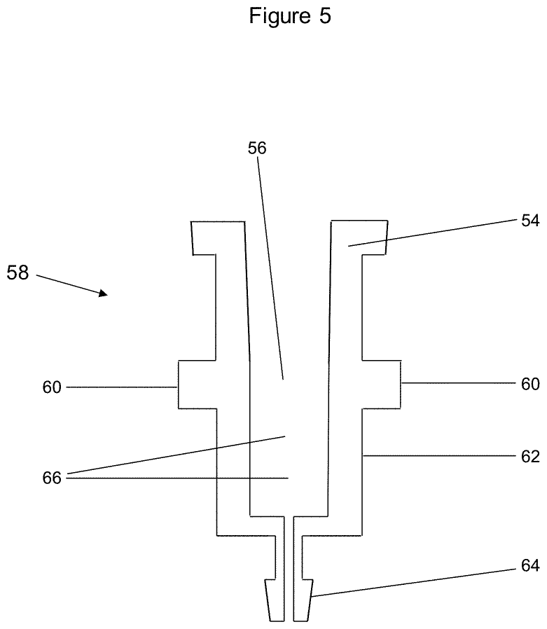

In some embodiments, the tubing 46 that is inserted through the port 44 applies an outward compression force on the male Luer port 44 such that the male Luer port 44 has a tighter fit with an inner wall of a mating female Luer lock (e.g., the female Luer lock 54 shown in FIG. 5) resulting in a higher friction at the interface thereby creating a better seal and a leak free connection. In some embodiments, the tubing 46 has an outer diameter that is narrower than the upper opening of the port 44 and wider than the lower opening of the port 44 such that the tubing applies an external compressive force on at least a portion of the interface between male Luer port 44 and the female port 54 when they are mated. This compression force due to the insertion of tube 46 creates an additional friction at the interface between the male Luer port 44 and female Luer port 54 thereby providing a leak free connection. In some embodiments the tubing 46 is at least partially inserted in the male Luer port 44 such that the opening of tubing 46 lies in between the upper opening and the lower opening of the mal Luer port 44. In some embodiments the tubing 46 extends beyond the lower opening of the male Luer port 44. In some embodiments, a leak free connection may be formed due to a tight fit between the male Luer port and the female Luer fitting without the use of a threads that are conventionally used to couple male and female Luer fittings.

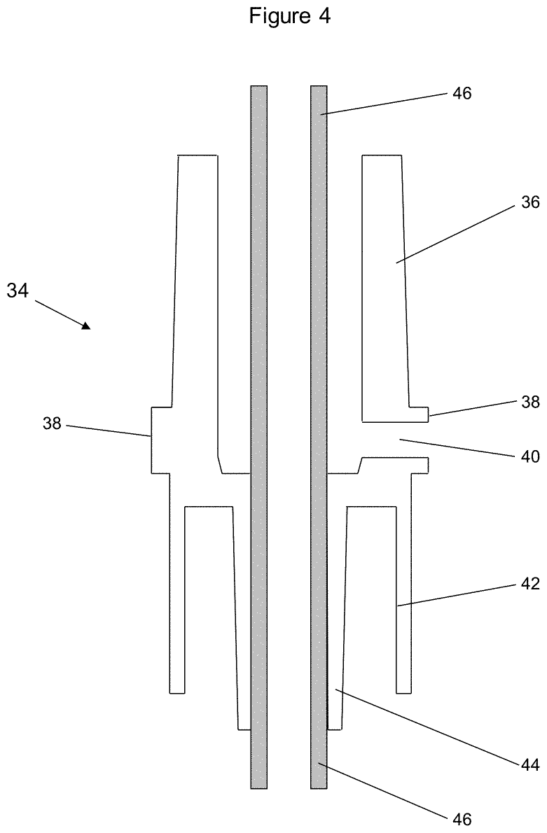

FIG. 4 shows a cross section of modified male Luer lock fitting 34, according to an embodiment. The male Luer lock fitting 34 (for example, ⅛ NPT×Luer lock fitting) has a passageway 33 drilled through the center of male Luer tip or port 44, passageway 33 having been enlarged (e.g., by drilling or during a manufacturing process thereof) to allow insertion of tubing 46 (for example with ⅛″ outside diameter). The tubing 46 is shown passing through passageway 33 of port 44 and a side port 40 (for example, with 1/16″ diameter) has been drilled through hex flat 38. A male pipe thread 36 (for example, a ⅛ NPT pipe thread) is shown with hex flats 38 present to allow fitting 30 to be installed into a female threaded opening (for example with ⅛ NPT threaded opening) with an open end wrench or similar tool. A Luer lock thread 42 (actual thread is not shown) is at the other end of the fitting and accepts female Luer lock 54. Male Luer tip or port 44, in use, interfaces with female Luer port 54 to create a leak free connection. In some embodiments, the tubing 46 inserted through the port 44 applies an outward compression force on the male Luer port 44 such that the male Luer port 44 has a tighter fit with the inner wall of the female Luer lock 54 resulting in a higher friction at the interface thereby creating a leak free connection. In some embodiments, the tubing 46 has an outer diameter that is narrower than the upper opening of the port 44 and wider than the lower opening of the port 44 such that the tubing applies an external compressive force on at least a portion of the interface between male Luer port 44 and the female port 54 when they are mated. This compression force due to the insertion of tube 46 creates an additional friction at the interface between the male Luer port 44 and female Luer port 54 thereby providing a leak free connection. In some embodiments the tubing 46 is at least partially inserted in the male Luer port 44 such that the opening of tubing 46 lies in between the upper opening and the lower opening of the male Luer port 44. In some embodiments the tubing 46 extends beyond the lower opening of the male Luer port 44. In some embodiments, a leak free connection is formed due to tight fit between the male Luer port and the female Luer fitting without the use of the threads, as previously described herein. In some embodiments, the inner wall of the passageway 33 is substantially parallel. In other words, the passageway 33 may have a taper of less than 0.01° from an upstream to a downstream end thereof such that passageway 33 may define a substantially constant cross-sectional width (e.g., diameter) from the upstream to the downstream end thereof. In some embodiments, the inner wall of the passageway 33 has a taper, the angle of the taper is in a range of about 0.01° to about 10° (e.g., about 6°).

Different from the male Luer fitting 32, the male Luer fitting 34 includes a side port 40 defined through a sidewall of the fitting 32. In some embodiments the side port 40 provides an additional fluid flow pathway from the male Luer fitting under the effect of an externally applied vacuum or a positive pressure of the fluid passing through the male Luer lock and the tubing 46. In some embodiments, the side port 40 may serve as a vent. In some embodiments, a portion of the fluid input at the male Luer lock passed through the tubing 46 out of the port 44 and another portion of the fluid flows through side port 40 providing an additional pathway for fluid pathway for additional purpose. In some embodiments the fluid flowing through the tubing 46 through the port 44 is utilized for a different purpose than the fluid flowing through the side port 40. In some embodiments the fluid flowing through the tubing 46 through the port 44 is utilized for a same purpose as the fluid flowing through the side port 40. In some embodiments, the side port 40 is used for purpose other than fluid flow.

FIG. 5 shows a cross section of a female Luer lock fitting 58, according to an embodiment. The female Luer lock fitting 58 (for example with a 1/16″ barb×¼-28 thread) includes a Luer port 54, hex flats 60 (for example with 5/16″ hex flats), thread 62 (for example a ¼-28 male thread) and barb 64 (for example with 1/16″ barb). Cavity 66 is located inside threads 62 and serves to extend passageway 56 allowing tubing 46 (for example with ⅛″ inside diameter) to extend from tip 44 in male Luer fittings modified to allow tubing 46 to pass through Luer tip 44.

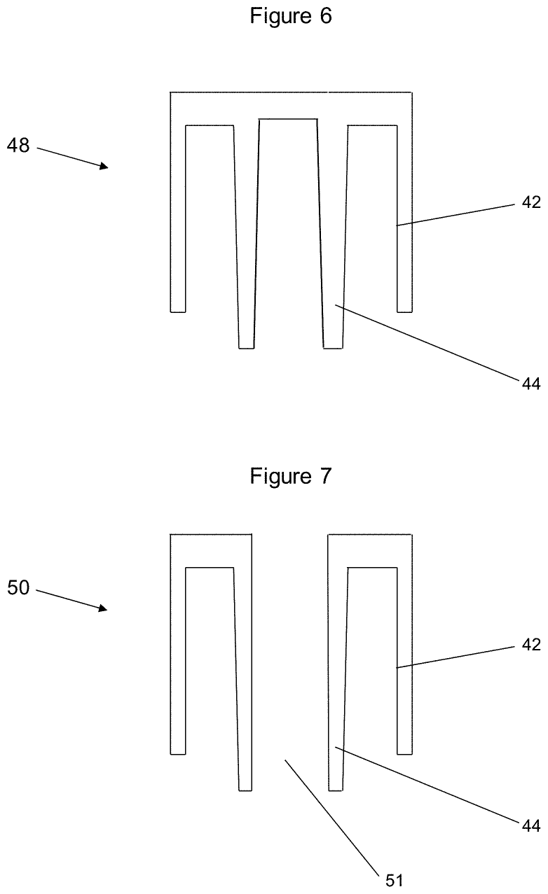

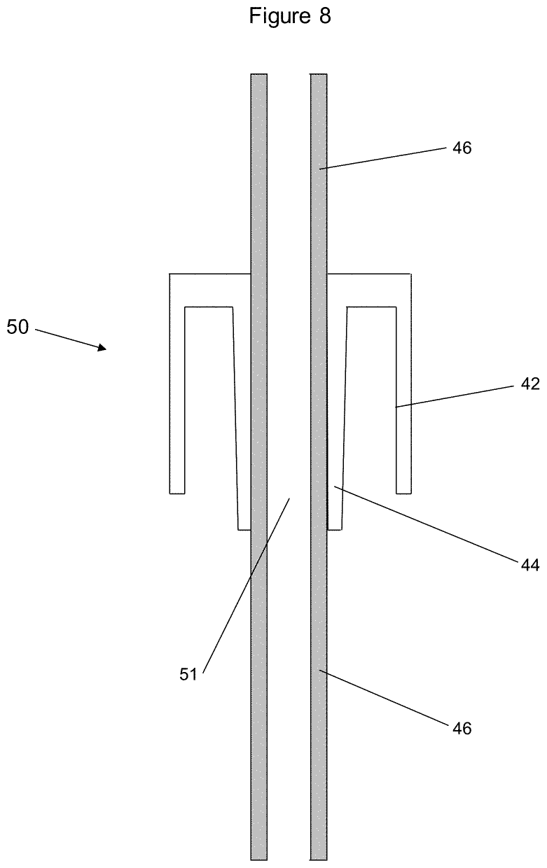

FIG. 6 shows a cross section of an unmodified Luer plug fitting 48, according to an embodiment. The unmodified Luer plug fitting 48 incudes Luer threads 42 and Luer tip or port 44. FIG. 7 shows a cross section of a modified Luer plug fitting 50 formed by modifying the fitting 48, according to an embodiment. The modified Luer plug fitting 50 includes a Luer thread 42 and Luer tip or port 44 and having passageway 51 created by drilling through the center of Luer port 44 such that an inner diameter passageway 51 is larger than an inner diameter of the unmodified port 44. In some embodiments, the passageway 51 can be formed during the injection molding of the modified Luer plug fitting 50. FIG. 8 shows a cross section of modified Luer plug fitting, according to an embodiment. In some embodiments, the inner wall of the passageway 33 is substantially parallel. In other words, the passageway 33 may have a taper of less than 0.01° from an upstream to a downstream end thereof such that passageway 33 may define a substantially constant cross-sectional width (e.g., diameter) from the upstream to the downstream end thereof. In some embodiments, the inner wall of the passageway 33 has a taper, the angle of the taper is in a range of about 0.01° to about 10° (e.g., about 6°).

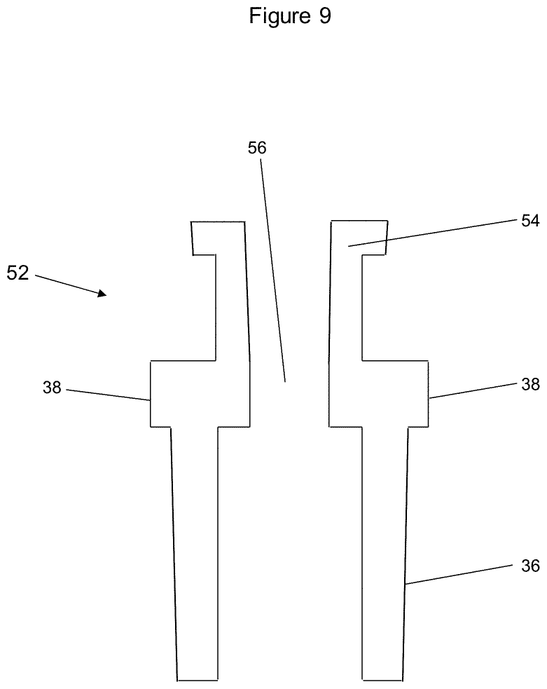

As shown in FIG. 8, the modified Luer plug fitting 50 includes a Luer thread 42 and Luer tip or port 44 with tubing 46 (for example, a tubing with ⅛″ outside diameter) passing through passageway 51 in the center of Luer port 44. In some embodiments, the tubing 46 inserted through the port 44 applies an outward compressive force on the male Luer port 44 such that the male Luer port 44 has a tighter fit with the inner wall of the female Luer port resulting in a higher friction at the interface thereby creating a leak free connection. In some embodiments, the tubing 46 is narrower than the upper opening of the port 44 and wider than the lower opening of the port 44 such that the tubing applies an external compressive force on at least a portion of the interface between the male Luer port 44 and the female Luer port 54 (shown in FIGS. 5 and 9) when they are mated. This compression force due to the insertion of tube 46 creates an additional friction at the interface between the male Luer port 44 and female Luer port 54 thereby providing a leak free connection. In some embodiments the tubing 46 is at least partially inserted in the male Luer port 44 such that the opening of tubing 46 lies in between the upper opening and the lower opening of the mal Luer port 44. In some embodiments the tubing 46 extends beyond the lower opening of the male Luer port 44. In some embodiments, the tubing can also extend into a cavity defined by a female Luer fitting, and even extend beyond the cavity of the female Luer lock up to a length of many meters (e.g., in a range of about 1 meters to about 10 meters, inclusive or even longer. In some embodiments, a leak free connection between the male Luer fitting 50 and the female Luer fitting is created without the use of threads, as previously described herein.

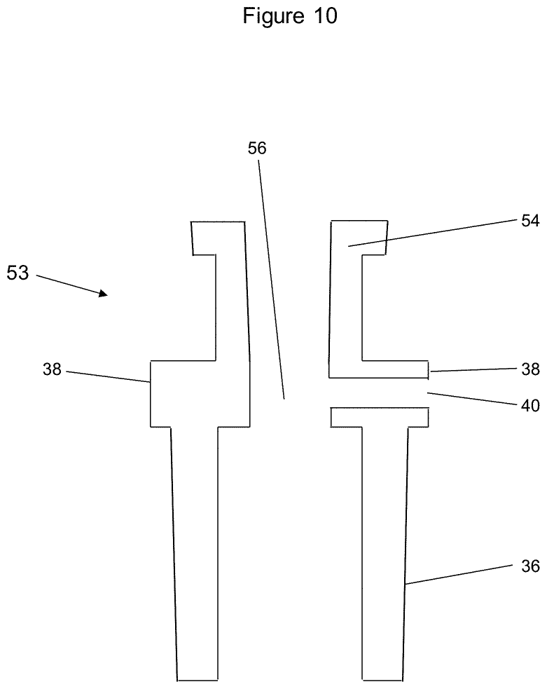

FIG. 9 shows a cross section of unmodified female Luer lock fitting 52 (for example, a ⅛ NPT×female Luer lock fitting) with Luer port 54, hex flats 38 (for example, with 7/16″ hex flats), thread 36 (for example with ⅛ NPT thread) and passageway 56 through the center of Luer port 54. FIG. 10 shows a cross section of modified female Luer lock fitting 53 formed my modifying the fitting 52, according to an embodiment. The female Luer lock fitting 53 (for example, a ⅛ NPT×female Luer lock fitting) includes a Luer port 54, hex flats 38 (for example, 7/16″ hex flats), thread 36 (for example, ⅛ NPT thread) and passageway 56 through the center of Luer port 54 with a side port 40 (for example a 1/16″ diameter side port) drilled through hex flat 38. In some embodiments the side port 40 provides an additional a fluid flow pathway from the male Luer fitting under the effect of an externally applied vacuum or positive pressure of the fluid passing through the male Luer lock and the tubing 46. In some embodiments, the side port could also act as a vent to atmosphere to prevent the buildup of pressure or vacuum if fluid was being added or removed from an otherwise airtight vessel. In some embodiments, a portion of the fluid input at the male Luer lock passed through the tubing 46 out of the port 44 and another portion of the fluid flows through side port 40 providing an additional pathway for fluid pathway for additional purpose. In some embodiments the fluid flowing through the tubing 46 through the port 44 is utilized for a different purpose than the fluid flowing through the side port 40. In some embodiments the fluid flowing through the tubing 46 through the port 44 is utilized for a same purpose as the fluid flowing through the side port 40.

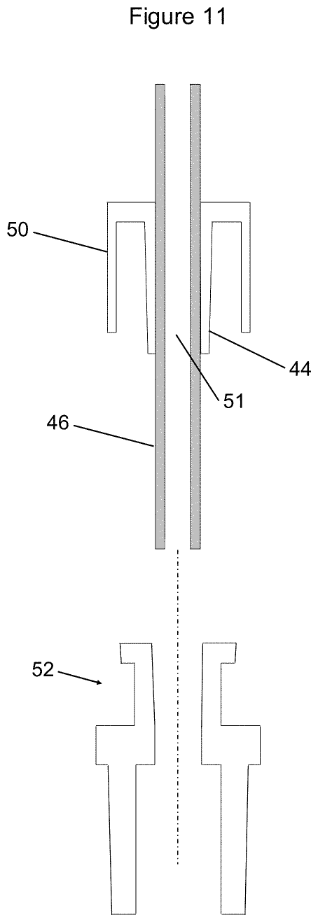

FIG. 11 shows a cross section of modified male Luer plug fitting 50 being mated with a female Luer lock fitting 52, according to an embodiment. The modified male Luer plug fitting 50 with tubing 46 (for example, with ⅛″ outside diameter) passing through the center of Luer port 44. Passageway 51 is created by drilling through the center of Luer port 44 to allow insertion of tubing 46. Also shown is female Luer lock fitting 52 (for example ⅛ NPT×female Luer lock fitting) that receives the male Luer lock fitting 50 being inserted into the female Luer lock fitting 52 along the dotted line shown in FIG. 11. The tubing 46 inserted through the port 44 applies an outward compression force on the male Luer port 44 such that the male Luer port 44 has a tighter fit with the inner wall of the female Luer port resulting in a higher friction at the interface thereby creating a leak free connection. In some embodiments, the tubing 46 is narrower than the upper opening of the port 44 and wider than the lower opening of the port 44 such that the tubing applies an external compressive force on at least a portion of the interface between male Luer port 44 and the female port 54 when they are mated. This compression force due to the insertion of tube 46 creates an additional friction at the interface between the male Luer port 44 and female Luer port 54 thereby providing a leak free connection.

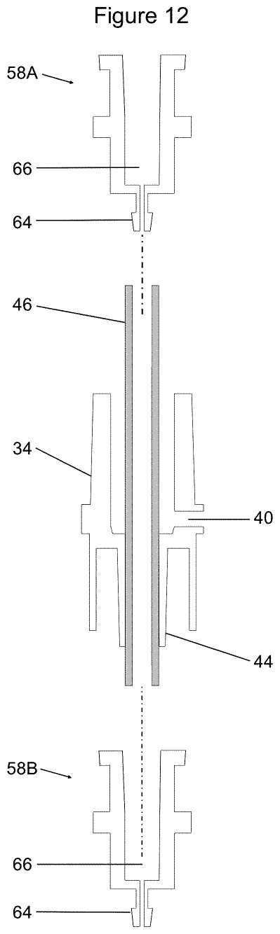

FIG. 12 shows a cross section of a male Luer lock fitting 34 coupled to two female Luer fittings 58A and 58B at the top end and a bottom end along an axis of the fitting 34, according to an embodiment. As shown, the first female Luer fitting 58A (for example, a 1/16″ barb×¼-28 thread×female Luer fitting) and the modified male Luer lock fitting 34 (for example, ⅛ NPT×male Luer lock fitting) are coupled to each other using a tubing 46 (for example, a ⅛″ outside diameter) passing through the center of Luer port 44. The male Luer lock fitting 34 is modified with a side port 40 (for example, with a 1/16″ diameter) that has been drilled through hex flat 38. Also shown is a second female Luer fitting 58B (for example, a 1/16″ barb×¼-28 thread×female Luer fitting) with dotted lines indicating how fittings 58A, 34, 58B and tubing 46 interface. Note that the upper end of tubing 46 is attached to barb 64 (for example, 1/16″ barb) on fitting 58A.

The lower end of tubing 46 extends beyond the end of tip 44 and extends into cavity 66 of fitting 58B. The tubing 46 inserted through the port 44 applies an outward compression force on the male Luer port 44 such that the male Luer port 44 has a tighter fit with the inner wall of the female Luer port resulting in a higher friction at the interface thus creating a leak free connection. In some embodiments, the tubing 46 is narrower than the upper opening of the port 44 and wider than the lower opening of the port 44 such that the tubing applies an external compressive force on at least a portion of the interface between male Luer port 44 and the female port 58B when they are mated. This compression force due to the insertion of tube 46 creates an additional friction at the interface between the male Luer port 44 and female Luer port 58B thereby providing a leak free connection.

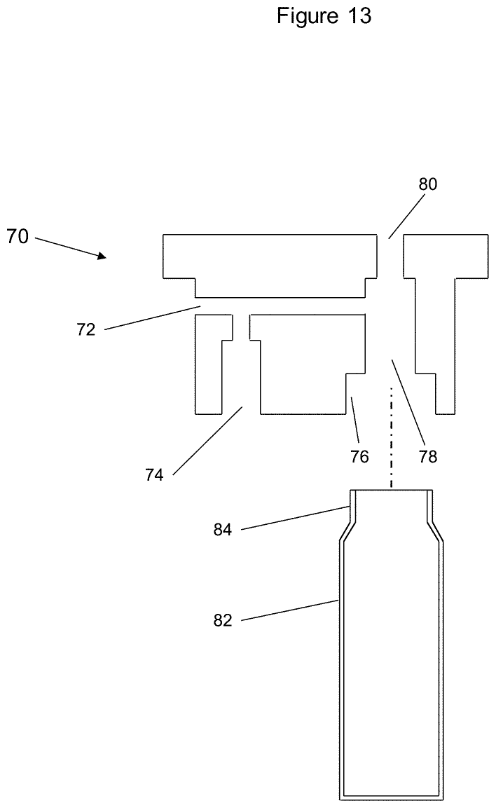

FIG. 13 shows a cross section of SPE system fluid management block and a vial couple to the block, according to an embodiment. The SPE system fluid management block 70 includes a cavity 76 to which a container 82 (for example, a vial with 40 mL volume and 24-414 thread) is coupled with thread 84 (for example, with a 24-414 thread). The hole 72 at the outside edge (for example with diameter 0.136″) extends into the cavity created by hole 78 (for example, with diameter 7/16″ with ¼ NPT female thread) and intersects with hole 74. In an example embodiment, the hole 72 has 8-32 thread at the outside edge extending to the intersection with hole 74. In another example embodiment, the hole 74 is 0.332″ in diameter reducing to 0.136″ diameter before intersecting with hole 72 and has ⅛ NPT threads at the bottom. In another example embodiment the hole 78 is 7/16″ in diameter reducing to 0.213″ at the top and has ¼ NPT threads at the bottom. In another example embodiment, the recess 76 has 24-414 threads cut into the interior cylindrical surface to accept vial 82 (for example with 40 mL volume and 24-414 thread). In another example embodiment, the hole 80 is about 0.213″ in diameter and has about¼-28 threads extending to the top of hole 78. In an example embodiment, the hole 80 may be offset to the right (towards the nearest edge of block 70) by approximately 0.1″. This offset may result in hole 80 intersecting the edge of hole 78 as opposed to the center of hole 78.

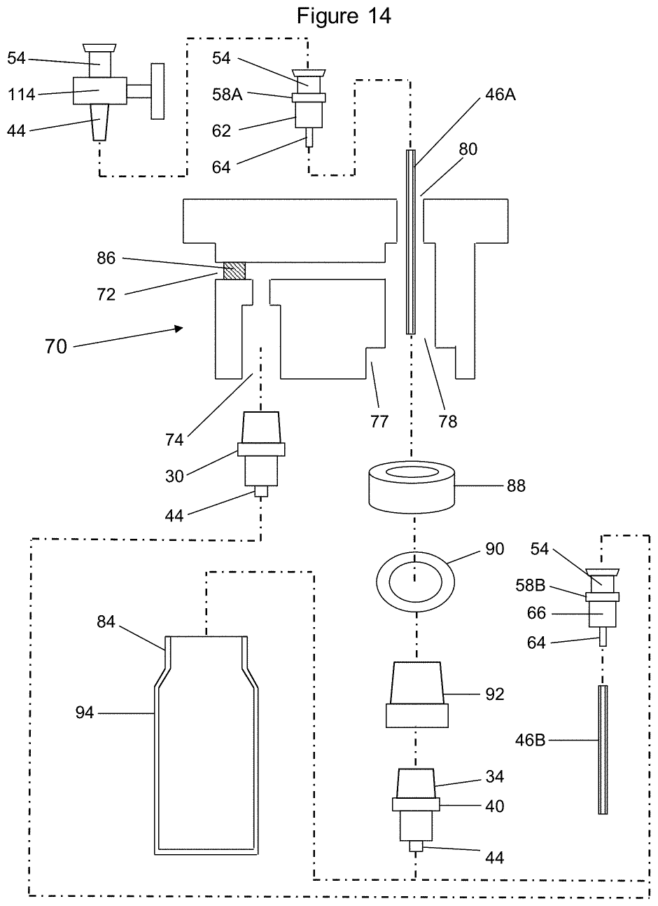

FIG. 14 shows a cross section of the SPE system fluid management block 70 and associated parts, and vial 94 (for example, with 20 mL volume and 24-414 thread). Hole 72 is installed with long set screw 86 (for example, 8-32 thread× 3/16″) installed. Hole 74 is shown with a line indicating the installation of fitting 30. Female Luer 58A (for example, with a×¼-28 thread× 1/16″ barb fitting) has tubing 46A attached to barb 64 and is installed in hole 80 with threads 62 (for example with ¼-28 threads). Tubing 46A extends through block 70, vial cap 88 (for example, with 24-414 thread), PTFE washer 90, bushing 92 (for example, ¼ NPT×⅛ NPT stainless steel bushing) and modified male Luer lock fitting 34 (for example with ⅛ NPT×) with the lower tip of tubing 46A passing through passageway 33 and extending from tip 44 by 2 to 3 mm.

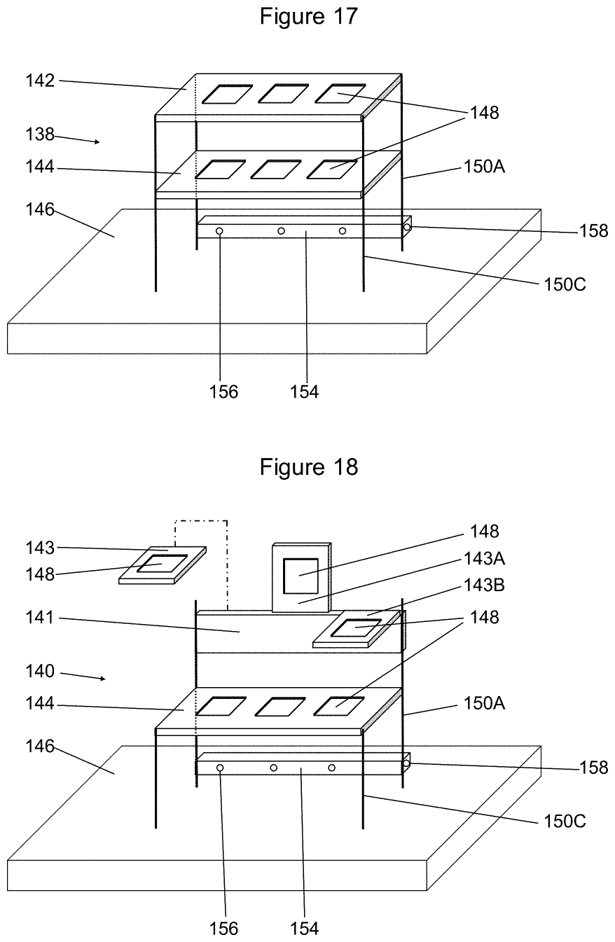

Vial cap 88 (for example, having 24-414 thread) may be press fit or friction fit into recess 77 and PTFE washer 90 sits at the top of vial cap 88. Both vial cap 88 and washer 90 are secured by bushing 92 which is threaded into hole 78. Washer 90 fits tightly around bushing 92 creating a seal between the two pieces. Fitting 34 is threaded into bushing 92. The vial 94 can thread into vial cap 88 with vial 94 positioned against washer 90 establishing an airtight seal with vial 94. Note that vial cap 88 can accept a container of any volume in the range of 20-60 mL Female Luer 58B (for example ×¼-28 thread× 1/16″ barb fitting) has tubing 46B attached to barb 64 (for example with diameter 1/16″). The end of tubing 46B that is not attached to fitting 58B is attached to port 156 of vacuum manifold 154, both shown in FIG. 17 and FIG. 18.

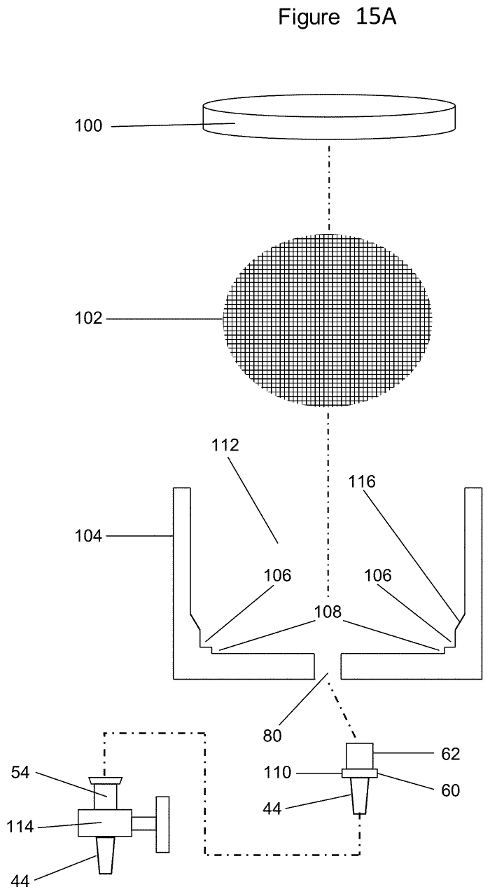

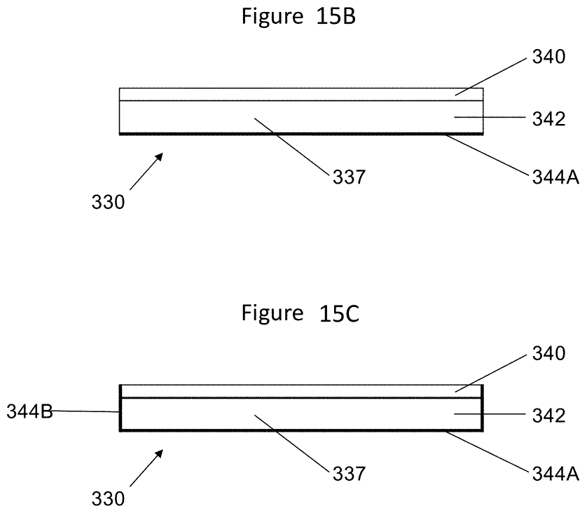

Vacuum manifold may also have a port which is connected to a container to collect waste liquids and a source of vacuum. The vial 94 (or other 24-414 thread container) is installed into vial cap 88 in one configuration. Fitting 58B can be attached to fitting 30. In this configuration vacuum can be applied to the interior of the vial 94. The vacuum passage may extend from fitting 30 through holes 74, 72 and 78, through bushing 92 and 1/16″ port 40 on fitting 34. In use fitting 110 on disk holder 104 would be installed into fitting 58A or, optionally, but preferentially, male×female 2 port Luer valve 114 may be installed onto fitting 58A of block 70 and fitting 110 of disk holder 104 installed on the second female Luer port of Luer valve 114 as shown in FIGS. 14 and 15. With vacuum being applied to vial 94, the 2 port Luer valve 114 in between fitting 58A on block 70 and fitting 110 on disk holder 104 can be used to control the flow of liquids from disk holder 104 into vial 94.

Liquids pass through SPE disk 100, recess 108 with porous member 102, fitting 110, Luer valve 114, fitting 58A and tubing 46A directly into vial 94. Port 40 in fitting 34 is part of a separate passage for the application of vacuum. Tubing 46A passes through, but is separate from, the passage used to apply vacuum to vial 94. In an alternate configuration vial 94 is removed from vial cap 88 and fitting 58B is attached directly to fitting 34 with the tip of tubing 46A extending into cavity 66 of fitting 58B. This allows liquids introduced into disk holder 104 to pass through SPE disk 100 and tubing 46A and into tubing 46B which is attached to a container used to collect liquids and a source of vacuum. This configuration is used to filter the water sample through SPE disk 100 as part of a solid phase extraction procedure. Two port Luer valve 114, optionally, but preferentially, located in between fitting 58A on block 70 and fitting 110 on disk holder 104 can be used to control the flow of liquids in this configuration. Luer valve 114 can also be used to control the flow of air or another gas through SPE disk 100. Note that bushing 92 and fitting 34 could be replaced by a single ¼ NPT×male Luer lock fitting with the same modifications as fitting 34.

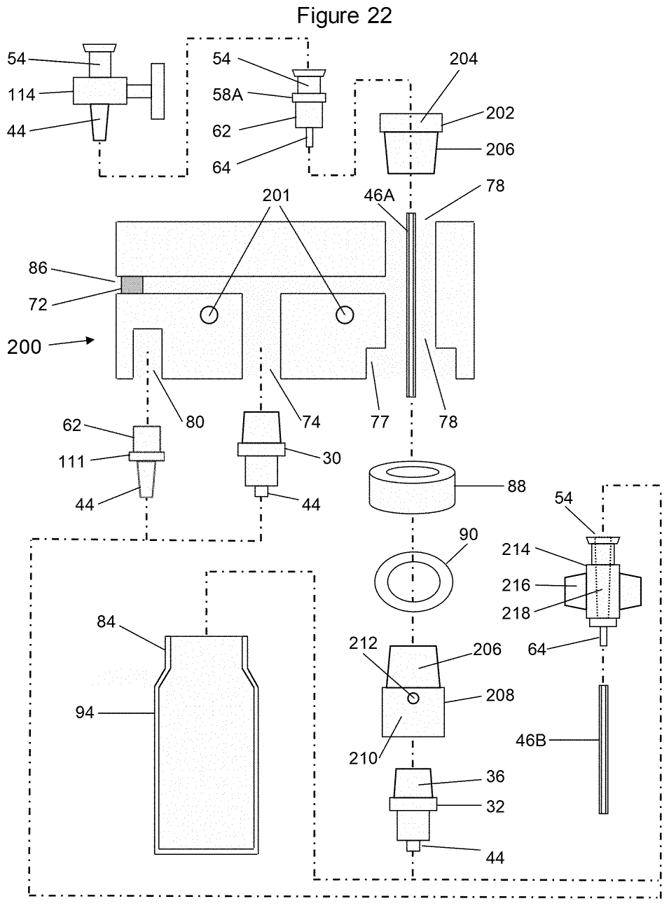

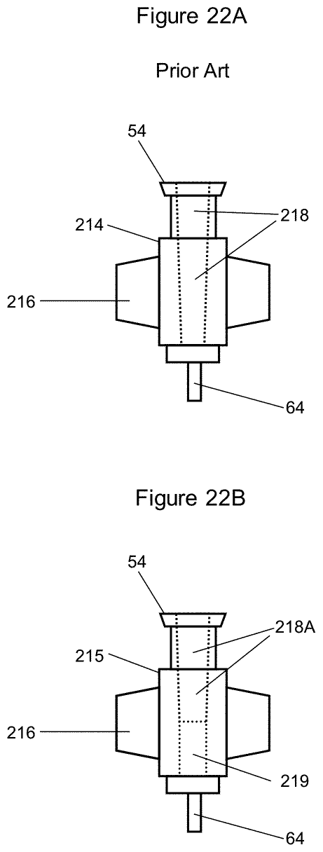

FIG. 15A Shows a cross section of solid phase extraction system disk holder with an SPE disk, a porous member, a male Luer fitting and a Luer valve 114, according to an embodiment. The disk holder 104 includes an SPE disk 100, porous member porous member102 (for example, porous membrane or screen made of stainless steel or another material), male Luer fitting 110 (for example ¼-28 thread×male Luer fitting) and Luer valve 114. Disk holder 104 is cylindrical with a closed bottom or base having concentric recess 106 (e.g., for securing SPE disk 100 with friction fit), concentric recess 108 (e.g., for accepting porous member 102) and centered hole 80 (for example, a 0.213″ diameter hole threaded with ¼-28 thread). In use during a solid phase extraction procedure, disk holder 104, with male Luer fitting 110 installed in hole 80, sits on Luer valve 114 installed on fitting 58A of block 70 as detailed in FIGS. 14 and 22. Disk holder 104 has cavity 112 angled section 116, first recess 106 and second recess 108. Porous member 102 fits into recess 108 and the top of porous member 102 is at approximately the same height as the bottom of recess 106 and creates a flat surface. Recess 108 and porous member 102 may have a diameter approximately 6 mm to 10 mm less than recess 106 and SPE disk 100. A 41 mm diameter, 20 mesh, woven stainless steel porous member having a thickness of around 0.75 mm is an example of a suitable porous member 102 for disk holder 104 when intended for use with a 47 mm SPE disk 100. SPE disk 100 fits into recess 106 and is secure enough in recess 106 that disk holder 104 can be inverted without SPE disk 100 falling out.

Recess 106 may be slightly larger than SPE disk 100. For example, the SPE disk 100 having a diameter of 47 mm may correspond to the recess 106 having a diameter of approximately 47.25 mm. The cylindrical edge of glass fiber SPE disk 100 is not perfectly uniform and smooth due to the fibrous nature of glass fiber. SPE disk 100 can be inserted into recess 106, aided by angled section 116 for securing SPE disk, with the lower portion or entire cylindrical edge of SPE disk 100, not being perfectly smooth and uniform, making intermittent contact with the cylindrical walls of recess 106. Angled section 116 at the bottom of cavity 112 and immediately above recess 106, aids in installing SPE disk 100 into recess 106. Angled section 116 also helps limit the amount of organic solvent necessary for the wash and elution steps of a solid phase extraction procedure by narrowing the bottom of cavity 112. In some embodiments, the thickness of the SPE disk may be less than, greater than, or equal to the thickness of the recess. In some embodiments, the diameter of the SPE disk may correspond to the diameter of the recess, for example the SPE disk may have a slightly smaller diameter than the recess diameter (for example, in a range of about 0.01 mm to about 0.25 mm, inclusive, less than the diameter of the recess). Porous member 102 may be slightly smaller than recess 108 or it may be approximately the same size as recess 108 and snap into place and be held securely. Fitting 110, a ¼-28 male thread×male Luer fitting (for example a ¼-28 male thread×male Luer fitting), is installed into hole 80 (for example with ¼-28 female threads). Fitting 110 serves to connect disk holder 104 to a solid phase extraction system and is used to apply vacuum to recess 108. Optionally, male×female 2 port Luer valve 114 may be installed onto fitting 58A of block 70 and fitting 110 of disk holder 104 to control the flow of liquids and gases through SPE disk 100. Vacuum applied to recess 108 is distributed under SPE disk 100 by the void space created by porous member 102. This vacuum aids in moving liquids or gases through SPE disk 100. In some embodiment the vacuum is applied to the recess 108. In some embodiments, the vacuum is applied to the cavity of the disk holder.

Removing SPE disk 100 from disk holder 104 is accomplished by inverting disk holder 104 and tapping it on a lab bench or other suitable surface. If porous member 102 is retained in recess 108 during this process disk holder 104 is ready for reuse. If porous member 102 comes out of disk holder 104 along with SPE disk 100 porous member 102 must be reinstalled into recess 108 before the next use of disk holder 104. Care must be exercised not to dislodge porous member 102 from recess 108 when installing SPE disk 100 into recess 106. In some embodiments, SPE disk 100 shown in FIG. 15A is same as SPE disk 331 as depicted in FIG. 15C. In some embodiments, SPE disk 100 is same as SPE disk 330 depicted in FIG. 15B. Various examples of SPE disks are described in detail in U.S. patent application Ser. No. 17/673,738, filed Feb. 16, 2022, and entitled “Solid Phase Extraction Disk,” the entire disclosure of which is incorporated herein by reference.

The disk holder 104 provides unexpected benefits over known disk holders. For example, not all known SPE disks may be suitable for use with SPE disk holder 104. Known SPE disks that do not have sorbent 268 uniformly distributed across the entire diameter, and have sorbent 268 located in a central disk shaped section surrounded by a substantial ring containing only glass fiber, are not suitable for use with disk holder 104. This construction, if used with disk holder 104, can allow the water sample being filtered by the disk to pass through the outer ring containing only glass fiber without contacting the central disk section containing sorbent 268. Many prior art manual SPE systems employ a clamping mechanism to secure SPE disk 100 to a porous base below and a reservoir above to contain the sample. This leaves the edge of SPE disk 100 exposed. In such known disks it is necessary to maintain vacuum under SPE disk 100 when liquid is in the reservoir to avoid having liquid seep out of the exposed edge of SPE disk 100. This is easily accomplished during the water filtration step by applying vacuum immediately after adding water to the reservoir above SPE disk 100 and maintaining vacuum until the filtration of the water sample is complete. During the elution step after the completion of the filtration of the water sample through SPE disk 100 it is necessary to add organic solvent to the reservoir above SPE disk 100.

Most SPE procedures specify a “soak” time of 1 to 3 minutes to allow analytes retained by SPE disk 100 to be released from SPE disk 100 and transferred to the organic solvent. During this soak period the vacuum must not be applied, or the organic solvent will pass through SPE disk 100 prematurely before the specified soak time has elapsed. With vacuum not being applied, this organic solvent may seep out of the exposed edge of SPE disk 100 resulting in loss of the organic solvent containing the analytes of interest. Some prior art manual and automated SPE systems use a disk holder design that has a cavity, similar to cavity 112 on disk holder 104 and employ a clamping mechanism often consisting a cylindrical collar that is inserted into the cavity similar to cavity 112, and held in place by a mechanism employing a threaded member to secure the collar so it is firmly clamped on the outer perimeter of the upper circular surface of SPE disk 100. In a disk holder intended for use with 47 mm diameter SPE disk 100 this collar might have an internal diameter of 41 mm and a height of 25 mm to 75 mm. The periphery of 47 mm SPE disk 100 that is under the collar is effectively sequestered and not available to filter the water sample. This reduces the available surface area for filtration by approximately 25%. Any analytes that do migrate into the perimeter of SPE disk 100 that is located under this collar may be difficult to effectively remove during the subsequent wash or elution with organic solvent. Such known disk holder designs often have a male Luer to interface with the SPE system in a similar manner to the use of fitting 110 at the base of disk holder 104.

Some other known disk holder designs employ a press fit of SPE disk 100 into a recess similar to recess 106, leaving the entire top surface exposed and available for filtration. This disk holder design specifies that the recess into which SPE disk 100 is press fit is of a smaller diameter than SPE disk 100. The intent is that SPE disk 100 will compress and conform to the smaller recess and establish a seal between the cylindrical edge of SPE disk 100 and the cylindrical wall of the smaller recess. In practice, installing SPE disk 100 into a smaller recess, particularly without the aid of angled section 116 of this invention, results in damage to SPE disk 100. This prior art design provides for the entire upper circular surface of SPE 100 to be available to filter the water sample. The concern that the water sample could migrate around the edge of SPE disk 100 without passing through SPE disk 100 is addressed in this prior at design by use of a recess smaller than SPE disk 100 as described above.

In contrast, disk holder 104 does not rely on attempting to establish a seal between recess 106 and SPE disk 100. Instead, the disk holder 104 relies on physical forces and chemical processes to prevent the passage of any analytes of interest around the sorbent containing portion of SPE disk 100. SPE disk 100, having the properties making it suitable for use with disk holder 104, specifically as follows.

SPE disk 100, constructed of glass fiber and containing sorbent 268, uniformly distributed across the entire diameter, or SPE disk 100, constructed of glass fiber and containing sorbent 268, uniformly distributed across the entire diameter and having a layer of glass fiber containing no sorbent that is not thicker than 0.4 mm covering the bottom circular surface or SPE disk 100, constructed of glass fiber and containing sorbent 268, uniformly distributed across the entire diameter, excepting a layer of glass fiber containing no sorbent that is not thicker than 0.4 mm covering the bottom circular surface, and the portion of the cylindrical outside edge that is exterior to the disk shaped, sorbent containing, portion of SPE disk 100, is suitable for disk holder 104. The layer of glass fiber containing no sorbent covering the bottom circular surface, and the portion of the cylindrical outside edge that is exterior to the disk shaped, sorbent containing, portion of SPE disk 100 is best exemplified by a glass fiber filter paper such as WHATMAN™ GFA PN: 1820-047 (for 47 mm diameter), WHATMAN™ GFA PN:1820-060 (for 60 mm Diameter) having a thickness of 0.3 mm.

In use, disk holder 104 may have a column of water between 15 mm and 60 mm high above the top surface of SPE disk 100. This creates a positive pressure relative to the ambient atmosphere at the interface of the water column and the top circular surface of SPE disk 100 of approximately 0.15 kPa for a 15 mm column of water. A typical SPE extraction procedure will employ a vacuum of between 50 kPa and 85 kPa relative to the ambient atmosphere below SPE disk 100 in recess 108, containing porous member 102. The interior of SPE disk 100 experiences a pressure gradient between these two pressures. This pressure differential holds SPE disk 100 in place with the bottom circular surface of SPE disk 100 pressed down on the bottom circular surface of recess 106 and the upper surface of porous member 102. The movement of liquid under the influence of vacuum would serve to close any gap between the bottom circular surface of SPE disk 100 and the bottom circular surface of recess 106.

In use with disk holder 104 in certain examples, SPE disk 100 as described above, may include a 0.3 mm glass fiber layer on the bottom circular surface if using the Whatman™ GFA filter paper described above. Several factors would limit or eliminate any passage of analytes of interest in the water sample being filtered, around the sorbent 268 portion of SPE disk 100. The preferred material of construction for disk holder 104 is PTFE. PTFE is extremely hydrophobic. This hydrophobicity of PTFE makes the wall of recess 106 hydrophobic. Given that the gap between the cylindrical edge of SPE disk 100 and the cylindrical wall of recess 106, assuming a reasonably central placement of 47 mm SPE disk 100 into 47.25 mm recess 106, leaves a gap between the cylindrical edge of SPE disk 100 and the cylindrical wall of recess 106 of 0.1 mm to 0.15 mm. This hydrophobicity of the PTFE cylindrical wall of recess 106 will limit or stop the migration of the water sample being filtered down the gap between the cylindrical wall of recess 106 and SPE disk 100. Recess 106 on disk holder 104, intended for use with 47 mm SPE disk 100, may be approximately 1 mm to 2 mm deep. Any water sample migrating in between the cylindrical wall of recess 106 and the cylindrical edge of SPE disk 100 in spite of this hydrophobicity, would be minimal in quantity and be subject to passing through the 0.3 mm to 0.4 mm thick layer of glass fiber not containing sorbent 268 (if present) covering the cylindrical edge of SPE disk 100 before reaching the bottom of recess 106. The water sample would then pass through sorbent 268 portion of SPE disk 100 traveling both laterally and downward to the edge of recess 108 containing porous member 102.

FIG. 15B shows a cross section of a first example of SPE Disk 330, constructed of glass fiber mesh or filter paper 344, wet-laid glass fiber and sorbent(s) 337. Filter paper 344 forms the bottom circular surface. Wet-laid glass fiber and sorbent layer 342 is formed on top of, and adhered to, filter paper 344. Wet-laid glass fiber layer 340 is formed on top of, and adhered to, glass fiber and sorbent layer 342. Glass fiber layer 340 forms the top circular surface of SPE disk 330. An example of filter paper 344 is exemplified by a glass fiber filter paper such as WHATMAN™ GFA PN: 1820-047 (for 47 mm diameter), WHATMAN™ GFA PN:1820-060 (for 60 mm Diameter) having a thickness of 0.3 mm. Other suitable material is available from numerous manufacturers.

FIG. 15C shows a cross section of a second example of SPE Disk 331, constructed of glass fiber mesh or filter paper 344, wet laid glass fiber and sorbent(s) 337. Filter paper 344 has center section 344A forms which forms the bottom circular surface of SPE disk 331. Filter paper 344 is folded and outer section 344B extends up the side of SPE disk 331 to the top circular surface of SPE disk 331. Glass fiber and sorbent layer 342 is formed on top of, and adheres to, filter paper center section 344A, and is within outer section 344B of filter paper 344. Wet laid glass fiber layer 340 is contained within, and extends to the top of filter paper outer section 344B. Wet laid glass fiber layer 340 forms the top circular surface of SPE disk 331. An example of filter paper 344 is exemplified by a glass fiber filter paper such as WHATMAN™ GFA PN: 1820-047 (for 47 mm diameter), WHATMAN™ GFA PN:1820-060 (for 60 mm Diameter) having a thickness of 0.3 mm. Other suitable material is available from numerous manufacturers.

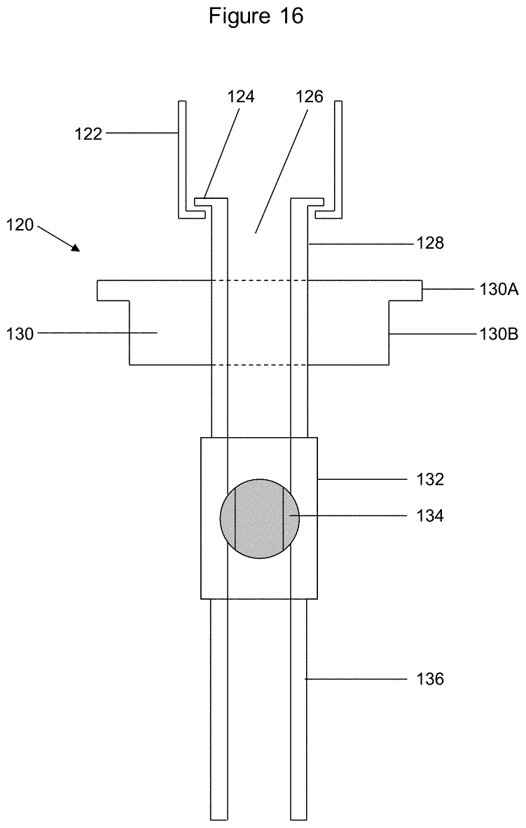

FIG. 16 shows a cross section of bottle holder and valve assembly 120. Hole cap 122 (for example with 33-430 bottle thread) attaches to the sample bottle containing the water sample to be extracted by the solid phase extraction procedure. Flange 124 is at one end of connecting tube 128 and seals to the top of the sample bottle when hole cap 122 is installed on the sample bottle. A thin gasket may be employed in between the sample bottle and flange 124 to aid in establishing a seal if necessary. The lower end of connecting tube 128 has ¾ NPT male threads and is installed into the upper port of ball valve 132. In some embodiments, 134 is a ball in ball valve shown in open position. Sample delivery tube 136 has ¾ NPT male threads on the upper end and is installed into the lower port of ball valve 132. In use the lower, unthreaded end of sample delivery tube 136 extends into cavity 112 of disk holder 104 and rests approximately 7 mm above SPE disk 100. Support block 130 may be installed at any point along connecting tube 128 in between hole cap 122 and ball valve 132. This allows the length from support block 130 to the lower end of sample delivery tube 136 to be adjusted. Support block 130 consists of two symmetrical pieces held together with screws that securely grip connecting tube 128 with semicircular cutouts on each side facing connecting tube 128. Ball valve 132 can be closed to allow bottle holder and valve assembly 120 with attached sample bottle to be inverted without loss of the water sample contained in the attached sample bottle. Inverting bottle holder and valve assembly 120 with attached sample bottle is necessary for the positioning of bottle holder and valve assembly 120, with attached sample bottle, in SPE system rack 138 as shown in FIG. 17 or SPE system rack 140 as shown in FIG. 18.

FIG. 17 shows a perspective view of solid phase extraction system rack 138 used for holding SPE extraction system components during use. Upper shelf 142 holds bottle holder and valve assembly 120 and lower shelf 144 holds solid phase extraction fluid management block 70. Block 70 is placed in, and may be secured in, holes 148 (e.g., round, square, rectangular, ovoid or any other shaped holes) in lower shelf 144. Support block 130 of bottle holder and valve assembly 120 is placed in square holes 148 in upper shelf 142. Lower section 130B of support block 130 fits into square hole 148 and upper section 130A of support block 130 rests on the upper surface of upper shelf 142.

Disk holder 104 is mounted on Luer valve 114 which is installed on fitting 58A of block 70. Rear legs 150A support upper shelf 142, lower shelf 144 and vacuum manifold 154. Front legs 150C support lower shelf. In place of rear legs 150A and front legs 150C, support for upper shelf 142, lower shelf 144 and vacuum manifold 154 could also be accomplished with two pieces of plastic or wood with the same width as upper shelf 142 and lower shelf 144 and of suitable height. System rack 138 sits on work surface 146 which may be located in a fume hood due to the solvents typically employed in solid phase extraction procedures. Note that square holes 148 on upper shelf 142 are offset to the right relative to square holes 148 on lower shelf 144. This is due to the asymmetry of fluid management block 70 with hole 80, into which fitting 58A and Luer valve 114 is installed, and on which disk holder 104 is mounted, is offset to the right.

In some embodiments, upper shelf 142 can be removable and can be installed oriented with square holes 148 offset to the left if desired. This would be done if installing block 70 oriented with fitting 58A and disk holder 104 on the left also. Upper shelf 142 is also removable, as after the water sample in the sample bottle attached to bottle holder and valve assembly 120 has been filtered through SPE disk 100, removing upper shelf 142 makes accessing disk holder 104 easier, as may be desirable to complete the remaining steps in the solid phase extraction procedure. Vacuum manifold 154 is attached to rear legs 150A and located below lower shelf 144. Vacuum manifold 154 has vacuum port(s) 156, with one vacuum port 156 for each fluid management block 70 that can be accommodated on shelf 144. Vacuum port(s) 156 is attached to tubing 46B with a suitable fitting and supplies vacuum to fitting 30 and fitting 34 on fluid management block 70. Vacuum port(s) 156 may have a valve attached to provide individual control to each vacuum port 156 and this valve may be, but is not necessarily, a Luer valve. This valve may be located at any point in between port 156 and fitting 30 or fitting 34 on block 70 through tubing 46B and attached fitting 58B. Vacuum manifold 154 also has vacuum port 158 which is connected to a waste-water container and vacuum source. Vacuum manifold 154 may also be equipped with a vacuum gauge to monitor vacuum. Rack 138 as shown can accommodate components for one to three sample extractions, being able to hold up to three block 70 and up to three bottle holder and valve assembly 120. Rack 138 can be configured to accommodate components for any number of sample extractions.

FIG. 18 shows a perspective view of solid phase extraction system rack 140 used for holding SPE extraction system components during use. Individual upper shelf segment 143/143B holds bottle holder and valve assembly 120 and lower shelf 144 holds solid phase extraction fluid management block 70. Block 70 is placed in, and may be secured in, square hole 148 in lower shelf 144 and bottle holder and valve assembly 120 is placed in square hole 148 of individual upper shelf segment 143/143B. Lower section 130B of support block 130 fits into square hole 148 and upper section 130A of support block 130 rests on the upper surface of individual upper shelf segment 143. Disk holder 104 is mounted on Luer valve 114 which is installed on fitting 58A of block 70.

Individual upper shelf segment 143A is shown in an upright position. This orientation improves access to disk holder 104 as may be desired to complete certain steps in a solid phase extraction procedure. Individual upper shelf segment 143A may be put into the upright orientation (143A) after the sample filtration step is complete and bottle holder and valve assembly 120, with attached sample bottle, has been removed from rack 140. Rear legs 150A support horizontal support 141, lower shelf 144 and vacuum manifold 154. Front legs 150C support lower shelf. In place of rear legs 150A and front legs 150C, support for horizontal support 141 and lower shelf 144 could also be accomplished with two pieces of plastic or wood with the same width as lower shelf 144 and of suitable height. System rack 140 sits on work surface 146 which may be located in a fume hood due to the solvents typically employed in solid phase extraction procedures. Note that individual upper shelf segment(s) 143/143B are offset to the right relative to square holes 148 on lower shelf 144. This is due to the asymmetry of fluid management block 70 with hole 80, into which fitting 58A and Luer valve 114 are installed and on which disk holder 104 rests are offset to the right. Individual upper shelf segment 143/143A could be installed oriented with an offset to the left if desired. This may be done if installing block 70 oriented with hole 80, fitting 58A, Luer valve 114 and disk holder 104 on the left also.

Individual upper shelf segment 143A is shown in an upright orientation and individual upper shelf segment 143B is shown folded down in the orientation necessary to support bottle holder and valve assembly 120 during filtering of the water sample. Individual upper shelf segment 143 can be securely attached to horizontal support 141 and is removable after the water sample in the sample bottle attached to bottle holder and valve assembly 120 has been filtered through SPE disk 100. Individual upper shelf segment 143 can be securely attached to horizontal support 141 and hold bottle holder and valve assembly 120 in a vertical orientation during the filtration of the water sample through SPE disk 100, as part of a SPE procedure. Removing individual upper shelf segment 143 makes accessing disk holder 104 easier and is an alternate configuration to an attached individual upper shelf segment 143 shown as being in the upright orientation (143A) and horizontal orientation (143B). Accessing disk holder 104 is necessary to complete the remaining steps in the solid phase extraction procedure after the water sample has been filtered through SPE disk 100 and bottle holder and valve assembly 120 has been removed. In some embodiments, individual upper shelf segment 143 and support block 130 may be combined as a single piece with block 130 part of, or securely attached to, individual upper shelf segment 143.

Vacuum manifold 154 is attached to rear legs 150A and located below lower shelf 144. Vacuum manifold has vacuum port(s) 156, with one vacuum port 156 for each fluid management block 70 that can be accommodated on rack 140. Vacuum port(s) 156 is attached to tubing 46B with a suitable fitting and supplies vacuum to fitting 30 and fitting 34 on fluid management block 70 through tubing 46B and attached fitting 58B. Vacuum port(s) 156 may have a valve attached to provide individual control to each vacuum port 156 and this valve may be, but is not necessarily, a Luer valve. This valve may be located at any point in between port 156 and fitting 30 or fitting 34 on block 70. Vacuum manifold 154 also has vacuum port 158 which is connected to a wastewater container and vacuum source. Vacuum manifold 154 may also be equipped with a vacuum gauge to monitor vacuum. Rack 140 as shown can accommodate components for one to three sample extractions, being able to hold up to three block 70 and up to three bottle holder and valve assembly 120. Rack 140 can be configured to accommodate components for any number of sample extractions.

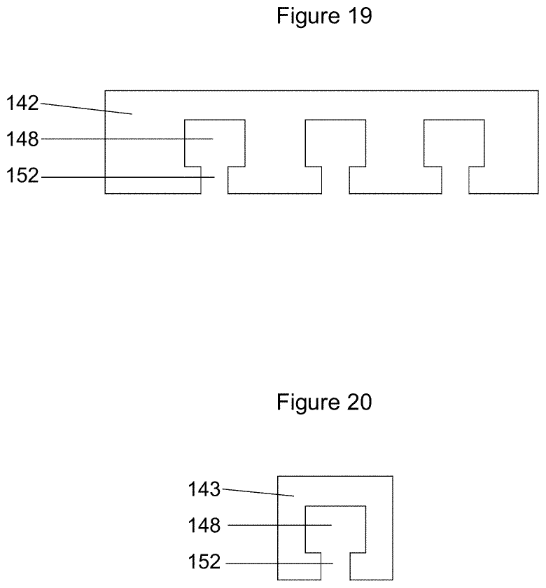

FIG. 19 shows a top view of upper shelf 142. Square holes 148 are shown with cutouts 152 going from the forward center edge of square holes 148 to the front edge of upper shelf 142. Cutout 152 allows bottle holder and valve assembly 120 with attached sample bottle to be more easily placed into square hole 148. Cutouts 152 eliminates the need to insert bottle holder and valve assembly 120 into square hole 148 by placing the bottom of sample delivery tube 136 into square hole 148 and lowering bottle holder and valve assembly 120 until support block 130 rests on shelf 142. Cutouts 152 allow bottle holder and valve assembly 120 to be placed in square hole 148 by passing connecting tube 128 below support block 130 through cutout 152. Cutout 152 makes for easier use of the SPE extraction system particularly if the system is located in a fume hood.

FIG. 20 shows a top view of individual upper shelf segment 143. Square hole 148 are shown with cutout 152 going from the forward center edge of square hole 148 to the front edge of individual upper shelf segment 143. Cutout 152 allows bottle holder and valve assembly 120 with attached sample bottle to be more easily placed into square hole 148. Cutouts 152 eliminates the need to insert bottle holder and valve assembly 120 into square hole 148 by placing the bottom of sample delivery tube 136 into square hole 148 and lowering bottle holder and valve assembly 120 until support block 130 rests on individual upper shelf segment 143. Cutouts 152 allow bottle holder and valve assembly 120 to be placed in square hole 148 by passing connecting tube 128 below support block 130 through cutout 152. Cutout 152 makes for easier use of the SPE extraction system particularly if the system is located in a fume hood.

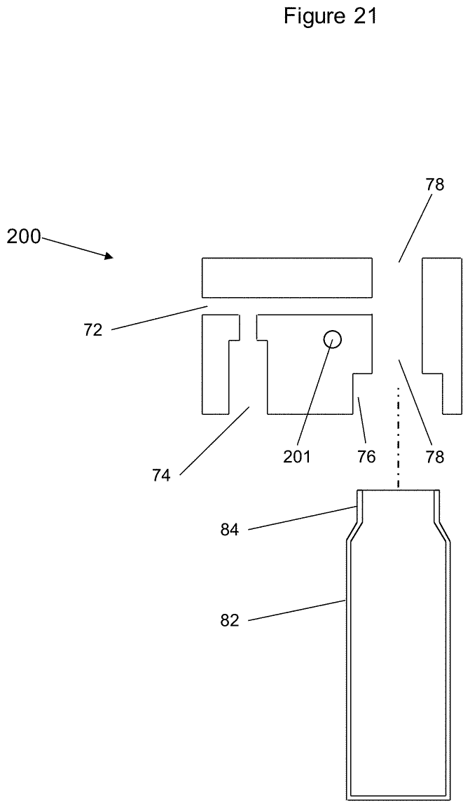

FIG. 21 shows a cross section of solid phase extraction (SPE) system fluid management block 200A having an opening (for example, a threaded hole) 201 for mounting block 200A on rack 220 or rack 240. Vial 82 (for example with a 24-414 thread) 84 is shown. Hole 72 (for example having 0.136″ diameter) intersects with hole 74 and extends into the cavity created by hole 78 (for example, having 7/16″ diameter). In some instances, the hole 72 has 8-32 thread at the outside edge extending to the intersection with hole 74. In some instances, hole 74 is 0.332″ in diameter reducing to 0.136″ diameter before intersecting with hole 72 and has ⅛ NPT threads at the bottom. In some instances, hole 78 is 7/16″ in diameter and has ¼-18 NPT threads at the top and bottom. The Recess 76 has threads (for example, 24-414 threads) cut into the interior cylindrical surface to accept vial 82 (for example, having 40 mL volume and 24-414 thread). Block 200A does not have provision for fitting 111 (e.g., installed in fluid management block) as shown in FIG. 22 but provision for fitting 111 could be provided on block 200A. Provision for fitting 111 could also be provided for elsewhere on the system rack.

FIG. 22 shows a cross section of solid phase extraction system fluid management block 200 and associated parts with threaded mounting hole 201 for mounting block 200 on rack 220, 240, 250 or 270. Two holes 201 are shown but additional mounting holes 201 may also be present. In some instances, the vial 94 shown in FIG. 22 may have a 20 mL volume and, 24-414 thread). Hole 72 has along set screw 86 installed (for example with a with 8-32 thread× 3/16″). Set screw 86 serves to close off hole 72 to allow vacuum to be established during use when vial 94 is installed in threaded cap 88, fitting 214 is installed on fitting 30 and tubing 46B is connected to a source of vacuum. Hole 74 is shown with a dotted line indicating the installation of fitting 30. Hole 78 may have threads (for example, ¼ NPT threads) at both the top and bottom. Female Luer 58A (for example, with ×¼-28 thread× 1/16″ barb fitting) has tubing 46A attached to barb 64 and is installed in thread fitting 202 (for example, with ¼-18 NPT×¼-28 thread fitting). Tubing 46A extends through fitting 202, block 200, vial cap 88 (for example, with ¼-18 NPT×¼-28), PTFE washer 90, bushing 208 (for example, ¼ NPT×⅛ NPT female stainless steel bushing with elongated 9/16″ hex flats) and modified male Luer lock fitting 32 (for example, with ⅛ NPT×) with the lower tip of tubing 46A passing through passageway 33 of fitting 32 and extending from tip 44 by about 1 mm to about 2 mm or even more. In some embodiments, the hole 204 is in stainless steel bushing threaded with female ¼-28 thread. In some embodiments, 206 is a ¼-18 NPT male tapered pip thread.

Vial cap 88 (for example with 24-414 thread) is press fit into recess 77 and PTFE washer 90 sits at the top of vial cap 88 and establishes a seal with vial 94 or another container with 24-414 or 24-410 thread. Both vial cap 88 and washer 90 are secured by bushing 208 which is threaded into hole 78. Washer 90 fits snuggly around bushing 208 creating a seal between the two pieces. Fitting 32 is threaded into bushing 208. Bushing 208 has a hole or port 212 in the hex flats, which may be used to apply a vacuum. Fitting 32 when installed in fitting 208 does not extend into fitting 208 far enough to block hole or port 212. Vial 94 (for example with a 20 mL, 24-414 thread) can thread into vial cap 88 with vial 94 seated up against washer 90 establishing an airtight seal between washer 90 and vial 94. During system use, with vial 94 installed into hole cap 88 and a seal established by washer 90, the vacuum passage extends from the interior of vial 94, through port 212 on bushing 208, through the interior of bushing 208, through hole 78, hole 72 and hole 74, through fitting 30, fitting 214 and tubing 46B which is connected to port 156 on vacuum manifold 154. Note that vial cap 88 can accept a 24-414 or similar thread container of any volume with 20 mL, 30 mL, 40 mL, 60 mL and 125 mL containers being other examples of containers that can be accepted.

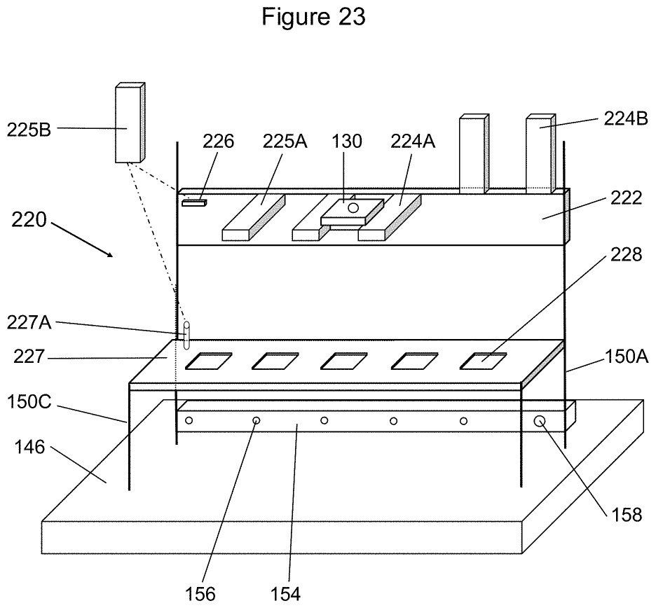

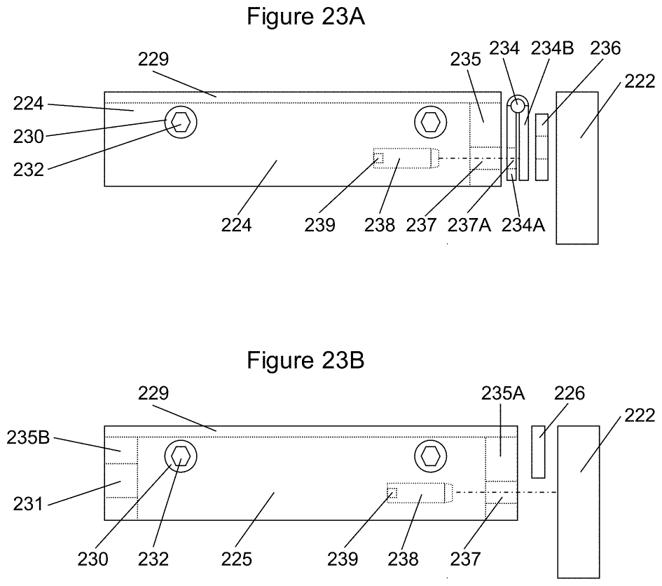

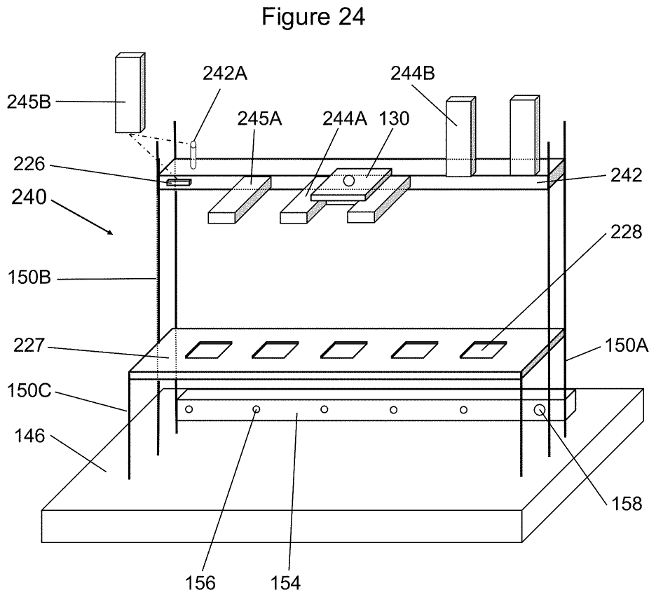

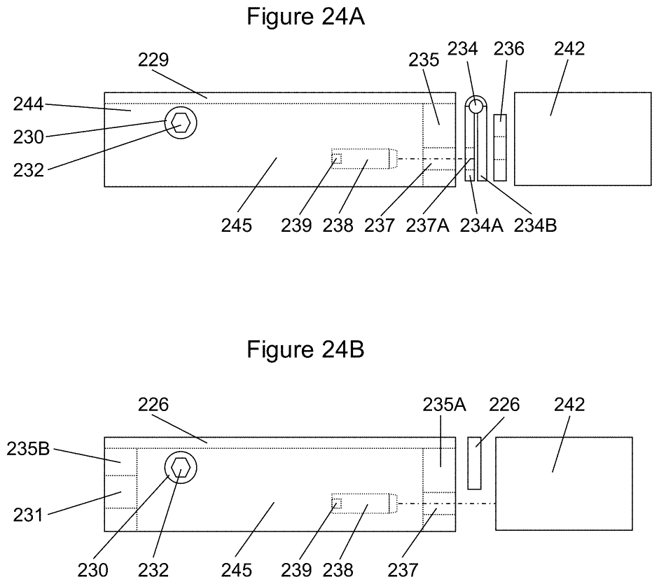

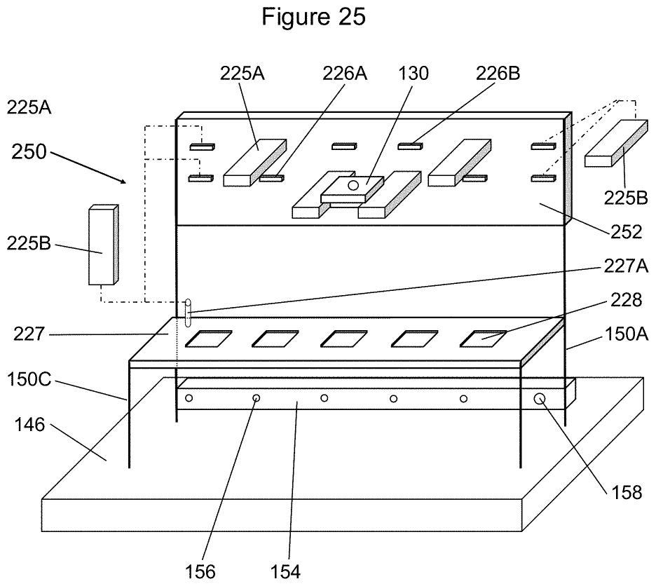

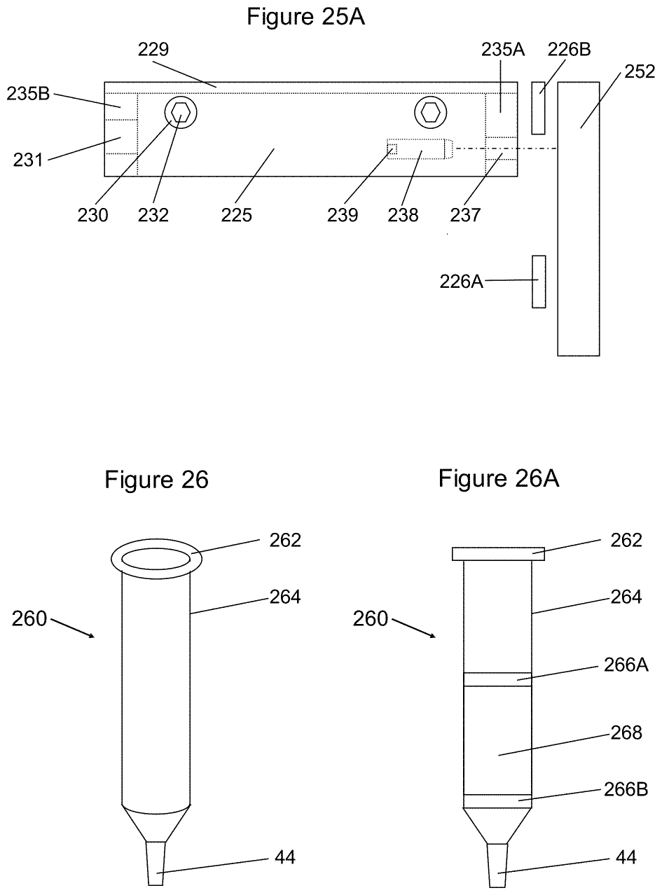

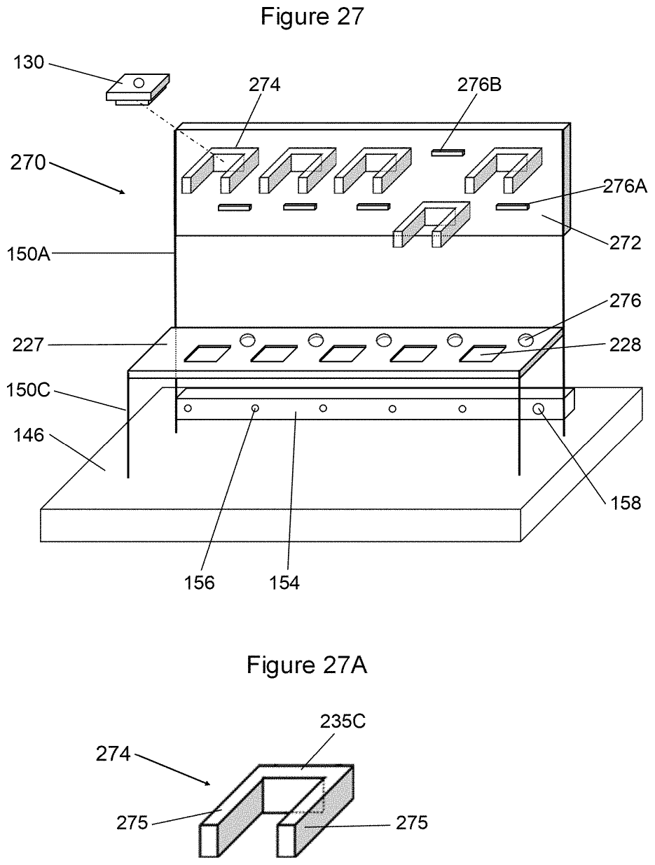

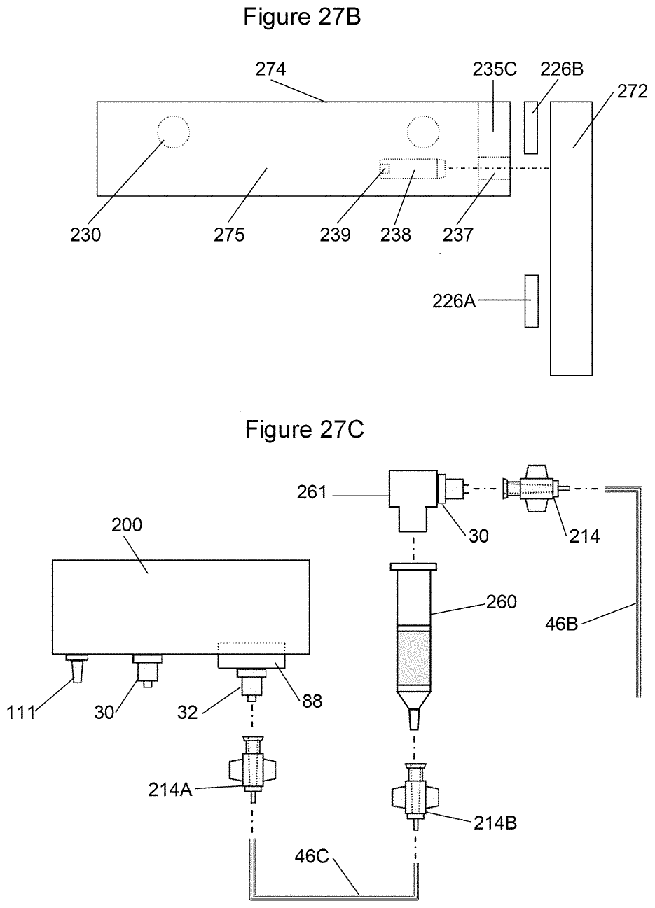

Female Luer with wing grips× 1/16″ barb fitting 214 (for example with × 1/16″ barb fitting) has tubing 46B attached to barb 64 (for example with 1/16″ barb). In some embodiments, barb fitting 214 is a Female Luer× 1/16″ barb fitting with winged grips on the end of cartridge connecting tubing that attaches to the modified male Luer fitting that is installed in the ¼ NPT×⅛ NPT fitting that secures the 24-414 thread hole cap. The end of tubing 46B not attached to fitting 212 is attached to port 156 on vacuum manifold 154, which are both shown in FIG. 17, FIG. 18, FIG. 23 FIG. 24, FIG. 25 and FIG. 27. Vacuum manifold 154 also has port 158 which is connected to a container to collect waste liquids and a source of vacuum. Vial 94 (for example with 20 mL volume and 24-414 thread) is installed into vial cap 88 in one configuration with fitting 214 attached to fitting 30. In this configuration vacuum can be applied to the interior of the vial 94. In use, fitting 110 on disk holder 104 may be installed into fitting 58A or, optionally, but preferentially, male Luer port 44 of male×female 2 port Luer valve 114. With vacuum being applied to vial 94, Luer valve 114 in between fitting 58A and fitting 110 on disk holder 104 can be used to control the flow of liquids or gases from disk holder 104 into vial 94. Liquids or gases pass through SPE disk 100, recess 108 with porous member 102, fitting 110, Luer valve 114, fitting 58A and tubing 46A directly into vial 94. Tubing 46A passes through, but is separate from, the passage used to apply vacuum to vial 94. In an alternate configuration vial 94 is removed from hole cap 88 and fitting 214 is attached directly to fitting 32 with the tip of tubing 46A extending into cavity 218 of fitting 214. This allows liquids introduced into disk holder 104 to pass through SPE disk 100, recess 108 with porous member 102, fitting 110, Luer valve 114, fitting 58A and tubing 46A and into fitting 214 with attached tubing 46B. Tubing 46B is attached, by way of vacuum manifold 154, to a container used to collect liquids and to a source of vacuum. This configuration is used to filter the water sample through SPE disk 100 as part of a solid phase extraction procedure. Note that bushing 208 and fitting 32 could be replaced by a single male Luer lock fitting (for example ¼ NPT×fitting) with the same or similar modifications as fitting 34 as shown in FIG. 4. In some instances, hole 80 has ¼-28 thread and does not connect to another passageway. Fitting 111 is installed in hole 80. Fitting 214 can be installed on fitting 111 when fitting 214 is not installed on fitting 30 or fitting 32. Fitting 111 is provided as a convenient means to plug fitting 214 to prevent the loss of vacuum to other block(s) 200.

FIG. 22A shows a cross section of a prior art female Luer Lock fitting (for, with 1/16″ barb) with wing grips 214 and with female Luer port 54, wing grips 216 and barb 64 (for example with 1/16″ barb). Cavity 218 extends from, and forms part of, female Luer port 54. Cavity 218 allows fitting 214 to be installed on modified male Luer fitting 32 or modified male Luer fitting 34 with tubing 46A extending beyond male Luer tip 44 of fitting 32 or fitting 34.

FIG. 22B shows a cross section of modified female Luer Lock fitting (for example with 1/16″ barb×) with wing grips 215 with female Luer port 54, wing grips 216 and barb 64 (for example with 1/16″). Cavity 218A extends from, and forms part of, female Luer port 54. Cylindrical cavity 219 begins at the point where tapered cavity 218A narrows (for example to approximately 0.1285″ diameter) and extends to the bottom or narrowest point of cavity 218 as shown in FIG. 22A. Cylindrical cavity 219 allows fitting 215 to be installed on modified male Luer fitting 32 or modified male Luer fitting 34 with tubing 46A extending beyond tip 44 of fitting 32 or fitting 34 as far as the bottom of cylindrical cavity 219. Tubing 46A (for example with a 0.125″ outside diameter) may extend a greater length from male Luer tip 44 of fitting 32 or fitting 34 when modified female Luer Lock fitting (for example, with a 1/16″ barb×) with wing grips 215 and cavity 219 is installed, rather than with unmodified female Luer Lock fitting (for example with 1/16″ barb) with wing grips 214.

FIG. 23 shows a perspective view of solid phase extraction system rack 220 used for holding SPE extraction system components during use. Rear legs 150A support horizontal member 222, shelf 227 and vacuum manifold 154. Front legs 150C support shelf 227. Horizontal member 222 is oriented in the same plane that passes through both rear legs 150A. Individual support leaf 224 is hinged and can be rotated up when not in use to facilitate access to disk holder 104 as is necessary to complete certain steps in a solid phase extraction procedure.

Leaf 224A is shown in the raised position. Leaf 224B is shown in the lowered position and holds bottle holder and valve assembly 120 with support block 130 resting on two adjacent leaves 224B. Horizontal member 222 may be adjustable so that the distance between leaf 224B or leaf 225B and shelf 227 can be adjusted. This adjustment can facilitate the use of SPE media of different heights, such as SPE cartridges, or the use or non-use of Luer valve 114 in between fitting 58A and fitting 110 of disk holder 104. Shelf 227 has openings 228 into which fluid management block(s) 200 are installed and secured with threaded fasteners or by other means. The threaded fasteners pass through suitable holes in the interior walls of opening(s) 228 and into threaded mounting hole(s) 201 of Block 200.

In use, disk holder 104 is mounted on fitting 58A or Female Luer port 54 of valve 114. Bottle holder and valve assembly 120 is placed in between two adjacent leaves 224B with support block upper section 130A resting on the top surface of two adjacent leaf 224B and support block lower section 130B resting in between two adjacent leaf 224B. Sample delivery tube 136 of bottle holder and valve assembly 120 extends into cavity 112 of disk holder 104. Detachable support leaf 225 serves the same purpose as hinged leaf 224 but instead of being hinged they are detachable. Leaf 225A is shown as detached when not in use as to facilitate access to disk holder 104 as is necessary to complete certain steps in a solid phase extraction procedure. Leaf 225B is shown as installed on horizontal support 222 and functions the same as hinged leaf 224B.

Hinged leaf(s) 224B may be rotated to the upright position and detachable leaf(s) 225B may be detached after completion of the sample filtration step for the sample(s) using the bottle holder and valve assemblies 120 they are supporting. System rack 220 sits on work surface 146 which may be located in a fume hood due to the solvents typically employed in solid phase extraction procedures. Note that leaf 224B and Leaf 225B are offset to the right relative to square openings 228 on shelf 227. This is due to the asymmetry of fluid management block 200 with hole 78, into which bushing 202 (e.g., stainless steel reducing bushing with a tapered ¼-18 NPT male thread and ¼-28 female thread), fitting 58A and Luer valve 114 are installed, and on which disk holder 104 rests, are offset to the right. System components could be manufactured and/or installed with an offset to the left if desired or with no offset if block 200 were manufactured with hole 78 centered in block 200. Vacuum manifold 154 is attached to rear legs 150A and located below shelf 227. Vacuum manifold has vacuum port(s) 156, with one vacuum port 156 for each block 200 that can be accommodated on rack 220. Vacuum port(s) 156 is attached to tubing 46B with a suitable fitting and supplies vacuum to fitting 30 and fitting 32 on fluid management block 200 through tubing 46B and attached fitting 214.

Vacuum port(s) 156 may have a valve attached to provide individual control to each vacuum port 156 and this valve may be, but is not necessarily, a Luer valve. This valve may be located at any point in between port 156 and fitting 30 or fitting 32 on block 200. Vacuum manifold 154 also has vacuum port 158 which is connected to a waste-water container and vacuum source. Vacuum manifold 154 may also be equipped with a vacuum gauge to monitor vacuum. Rack 220 as shown can accommodate components for one to five sample extractions, being able to hold up to five block(s) 200 and up to five bottle holder and valve assembly 120. Rack 220 can be configured to accommodate components for any number of sample extractions.

FIG. 23A shows a cross section view of hinged support leaf 224 for use on system rack 220 as depicted in FIG. 23. Also shown is horizontal member 222 to which leaves 224 are attached by means of hinge 234. In between hinge 234 and horizontal member 222 is standoff 236 which allows leaf 224, when raised to the upright position, to rotate beyond 90° to a position approximately 135° from the orientation shown in FIG. 24. When rotated 135° from the orientation depicted in FIG. 24, leaf 224 will remain securely in the raised orientation and not inadvertently fall back down to the lowered orientation.

Leaf 224 may be constructed with a variety of materials or techniques. Leaf 224, as shown in FIG. 24, is constructed of aluminum C-channel and base 229 is the upper horizontal surface of leaf 224. Leaf 224 has end piece 235 located at one end of leaf 224 to provide a surface on which to mount leaf 234A of hinge 234. End piece 235 also has hole 237 to accept set screw 238 (for example with ¼-28 threads to accept ¼-28 thread set screw 238). Hole 237 lines up with hole 237A in leaf 234A of hinge 234. Hole 237A is separate from the holes used to mount leaf 234A to end piece 235. In some instances, Hole 237A, may also be threaded with ¼-28 thread. Set screw 238, when installed in hole 237, and passing through hole 237A, is in contact with leaf 234B of hinge 234. Leaf 234B is attached to horizontal member 222 with the screws (not shown) used to attach leaf 234B to horizontal member 222 passing through standoff 236. Set screw 238 can be adjusted to make leaf 224 level when in the lowered position.

Leveling leaf 224 allows leaf 224 to hold support 130 of bottle holder and valve assembly 120 in a horizontal orientation during the sample filtration step of an SPE procedure. Set screw 238 has hexagonal recess 239 which, for example, accepts an Allen wrench to facilitate installation and adjustment of set screw 238. In some instances, leaf 224 has pins 230, which may have ¼-28 thread socket cap screws. Lower section 130B of support block 130 sits in between pins 230 with pins 230 positioning support block 130 of bottle holder and valve assembly 120 so that sample delivery tube 136 rests approximately in the center of cavity 112 of disk holder 104. Leaf 224, if not located at either end of horizontal member 222 will have pins 230 located on both sides of leaf 224 to facilitate the use of bottle holder and valve assembly 120 on either side of leaf 224. Leaf 224, if located at either end of horizontal member 222, need only have pins 230 on the side of leaf 224 that will be used to support bottle holder and valve assembly 120. Pins 230, as shown in FIG. 24, are a socket cap screw (for example with a ¼-28 thread), having hexagonal recess 232 to accept an Allen wrench to facilitate installation. Pins 230 could also be a piece of aluminum welded or otherwise affixed on leaf 224 to serve the same purpose. Any means to locate support block 130 of bottle holder and valve assembly 120 in the correct location on leaf 224 is suitable. While leaf 224 is shown as includes including pins 230, in other embodiments, the pins 230 may not be present for leaf 224 to hold bottle holder and valve assembly 120. Pins 230 may be also present on detachable leaf 225 and have the same placement, locations and function as pins 230 on hinged leaf 224.

FIG. 23B shows a cross section view of detachable support leaf 225 for use on system rack 220 as depicted in FIG. 23. Also shown is horizontal member 222 to which leaves 225 are attached by means of mounting point or mechanism 226. Leaf 225 may be constructed with a variety of materials or techniques. Leaf 225, as shown in FIG. 23B, is constructed of aluminum C-channel and base 229 is the upper horizontal surface of leaf 225. Leaf 225 has end piece 235 located at one end of leaf 225 to provide a surface on which a mechanism to engage with mounting point 226 is installed. End piece 235 also has hole 237 (for example with ¼-28 threads) to accept set screw 238 (for example with ¼-28 thread). Set screw 238, when installed in hole 237, can be adjusted to make leaf 225 level when installed on horizontal member 222.

Leveling leaf 225 allows leaf 225 to hold support 130 of bottle holder and valve assembly 120 in a horizontal orientation during the sample filtration step of an SPE procedure. Set screw 238 has hexagonal recess 239 which accepts an Allen wrench to facilitate installation and adjustment of set screw 238. Leaf 225 has pins 230, which may be, but are not necessarily, socket cap screws (for example with ¼-28 thread). In use, support block 130 sits in between two adjacent leaf 225. Lower section 130B of support block 130 sits in between pins 230 with pins 230 positioning support block 130 of bottle holder and valve assembly 120 so that sample delivery tube 136 rests approximately in the center of cavity 112 of disk holder 104. Leaf 225, if not located at either end of horizontal member 222 will have pins 230 located on both sides of leaf 225 to facilitate the use of bottle holder and valve assembly 120 on either side of leaf 225. In practice, as leaf 225 is detachable, it may be desirable to have all leaves 225 have pins 230 on both sides as this would allow all leaves 225 to be used on any mounting point 226. Pins 230, as shown in FIG. 23B, may include a socket cap screw (for example ¼-28 thread), having hexagonal recess 232 to accept an Allen wrench to facilitate installation. Pins 230 could also be a piece of aluminum welded or otherwise affixed on leaf 225 to serve the same purpose. Any means to locate support block 130 of bottle holder and valve assembly 120 in the correct location on leaf 225 is suitable. Pins 230 need not be present for leaf 225 to hold bottle holder and valve assembly 120, but leaf 225 having pins 230 is preferred. Leaf 225 also has end piece 235A, located at the other end of leaf 225 than that used to mount leaf 225 to mounting point 226. End piece 235A has hole 231 which engages with storage peg 227A. Leaf 225 can be placed on peg(s) 227A when not installed on horizontal support 222. In some embodiments, 235B is an end piece on detachable support leaf containing hole for placing the leaf on storage peg located on horizontal member or a shelf when not in use.

FIG. 24 shows a perspective view of solid phase extraction system rack 240 used for holding SPE extraction system components during use. Individual support leaf 244 is hinged and can be rotated up when not in use to facilitate access to disk holder 104 as is necessary to complete certain steps in a solid phase extraction procedure. Leaf 244A is shown in the raised position. Leaf 244B shown in the lowered position holds bottle holder and valve assembly 120 with support block 130 resting on two adjacent leaf 244B. Shelf 227 has openings 228 into which fluid management block 200 is installed and secured with threaded fasteners. The threaded fasteners pass through suitable holes in the interior walls of opening(s) 228 and into threaded mounting hole 201 of Block 200. In use, disk holder 104 is mounted on fitting 58A or Female Luer port 54 of valve 114.

Bottle holder and valve assembly 120 is placed in between two adjacent leaf 244B with support block upper section 130A resting on the top surface of two adjacent leaf 244B and support block lower section 130B resting in between two adjacent leaf 244B. Sample delivery tube 136 of bottle holder and valve assembly 120 extends into cavity 112 of disk holder 104. Detachable support leaf 245 serves the same purpose as hinged leaf 244 but instead of being hinged are detachable. Leaf 245A is shown as detached when not in use as to facilitate access to disk holder 104 as is necessary to complete certain steps in a solid phase extraction procedure. Leaf 245B is shown as installed on horizontal support 242 and functions the same as hinged leaf 244B. Hinged leaf(s) 244B may be rotated to the upright position and detachable leaf(s) 245B may be detached after completion of the sample filtration step for the sample(s) using the bottle holder and valve assemblies 120 they are supporting.

Horizontal member 242 has peg 242A onto which leaf 245A may be placed for storage while detached and not in use. Rear legs 150A and middle legs 150B support horizontal member 242 and shelf 227. Front legs 150C support shelf 227. Horizontal member 242 is oriented in a plane at a right angle to the plane that passes through both rear legs 150A. System rack 240 sits on work surface 146 which may be located in a fume hood due to the solvents typically employed in solid phase extraction procedures. Note that leaf 244B and Leaf 245B are offset to the right relative to square openings 228 on shelf 227. This is due to the asymmetry of fluid management block 200 with hole 78, into which bushing 202, fitting 58A and Luer valve 114 are installed, and on which disk holder 104 rests, are offset to the right. System components could be manufactured and/or installed with an offset to the left if desired or with no offset if block 200 were manufactured with hole 78 centered in block 200.

Vacuum manifold 154 is attached to rear legs 150A and located below shelf 227. Vacuum manifold has vacuum port(s) 156, with one vacuum port 156 for each block 200 that can be accommodated on rack 240. Vacuum port(s) 156 is attached to tubing 46B with a suitable fitting and supplies vacuum to fitting 30 and fitting 32 on fluid management block 200 through tubing 46B and attached fitting 214. Vacuum port(s) 156 may have a valve attached to provide individual control to each vacuum port 156 and this valve may be, but is not necessarily, a Luer valve. This valve may be located at any point in between port 156 and fitting 30 or fitting 32 on block 200. Vacuum manifold 154 also has vacuum port 158 which is connected to a wastewater container and vacuum source. Vacuum manifold 154 may also be equipped with a vacuum gauge to monitor vacuum. Rack 240 as shown can accommodate components for one to five sample extractions, being able to hold up to five block(s) 200 and up to five bottle holder and valve assembly 120. Rack 240 can be configured to accommodate components for any number of sample extractions.

FIG. 24A shows a cross section view of individual hinged support leaf 244 for use on the system rack 240 as depicted in FIG. 25. Also shown is horizontal member 242 to which leaves 244 are attached by means of hinge 234. In between hinge 234 and horizontal member 242 is standoff 236 which allows leaf 244, when raised to the upright position, to rotate beyond 90° to a position approximately 135° from the orientation shown in FIG. 26. When rotated 135° from the orientation depicted in FIG. 26, leaf 244 will remain securely in the raised orientation and not inadvertently fall back down to the lowered orientation. Leaf 244 may be constructed with a variety of materials or techniques. Leaf 244, as shown in FIG. 26, is constructed of aluminum C-channel and base 229 is the upper horizontal surface of leaf 244.

Leaf 244 has end piece 235 located at one end of leaf 244 to provide a surface on which to mount hinge 234. End piece 235 also has hole 237 (for example, with ¼-28 threads) to accept set screw 238 (for example, ¼-28 thread). Hole 237 lines up with hole 237A in leaf 234A of hinge 234. Hole 237A is separate from the holes used to mount leaf 234A to end piece 235. Hole 237A, may be, but is not necessarily, also threaded (for example, with ¼-28 thread). Set screw 238, when installed in hole 237, and passing through hole 237A, is in contact with leaf 234B of hinge 234. Leaf 234B is attached to horizontal member 242 with the screws (not shown) used to attach leaf 234B to horizontal member 242 passing through standoff 236. Set screw 238 can be adjusted to make leaf 244 level when in the lowered position. Leveling leaf 244 allows leaf 244 to hold support 130 of bottle holder and valve assembly 120 in a horizontal orientation during the sample filtration step of an SPE procedure. Set screw 238 has hexagonal recess 239 which accepts an Allen wrench to facilitate installation and adjustment of set screw 238. Leaf 244 has pin 230, which may be, but is not necessarily, a socket cap screw (for example with ¼-28 thread). Lower section 130B of support block 130 sits in between pin 230 and horizontal member 242 with pins 230 and horizontal member 242 positioning support block 130 of bottle holder and valve assembly 120 so that sample delivery tube 136 rests approximately in the center of cavity 112 of disk holder 104. Leaf 244, if not located at either end of horizontal member 242 will have pins 230 located on both sides of leaf 244 to facilitate the use of bottle holder and valve assembly 120 on either side of leaf 244. Leaf 244, if located at either end of horizontal member 242, need only have pin 230 on the side of leaf 244 that will be used to support bottle holder and valve assembly 120. Pin 230, as shown in FIG. 26, is a socket cap screw (for example ¼-28 thread), having hexagonal recess 232 to accept an Allen wrench to facilitate installation. Pin 230 could also be a piece of aluminum welded or otherwise affixed on leaf 244 to serve the same purpose. Any means to locate support block 130 of bottle holder and valve assembly 120 in the correct location on leaf 244 is suitable. Pins 230 need not be present for leaf 244 to hold bottle holder and valve assembly 120 but leaf 244 having pins 230 may provide a better grip for holding bottles. Pins 230 are also present on detachable leaf 245 and have the same placement, locations and function as pins 230 on hinged leaf 244.

FIG. 24B shows a cross section view of detachable support leaf 225 for use on system rack 240 as depicted in FIG. 24. Also shown is horizontal member 242 to which leaves 225 are attached by means of mounting point or mechanism 226. Leaf 225 may be constructed with a variety of materials or techniques. Leaf 225, as shown in FIG. 24B, is constructed of aluminum C-channel and base 229 is the upper horizontal surface of leaf 225. Leaf 225 has end piece 235 located at one end of leaf 225 to provide a surface on which a mechanism to engage with mounting point 226 is installed. End piece 235 also has hole 237 (for example with ¼-28 threads) to accept set screw 238 (for example with ¼-28 thread). Setscrew 238, when installed in hole 237, can be adjusted to make leaf 225 level when installed on horizontal member 242.

Leveling leaf 225 allows leaf 225 to hold support 130 of bottle holder and valve assembly 120 in a horizontal orientation during the sample filtration step of an SPE procedure. Set screw 238 has hexagonal recess 239 which accepts an Allen wrench to facilitate installation and adjustment of set screw 238. Leaf 225 has pins 230, which may be, but are not necessarily, socket cap screws (for example with ¼-28 thread). In use, support block 130 sits in between two adjacent leaves 225. Lower section 130B of support block 130 sits in between pins 230 with pins 230 positioning support block 130 of bottle holder and valve assembly 120 so that sample delivery tube 136 rests approximately in the center of cavity 112 of disk holder 104. Leaf 225, if not located at either end of horizontal member 242 will have pins 230 located on both sides of leaf 225 to facilitate the use of bottle holder and valve assembly 120 on either side of leaf 225. In practice, as leaf 225 is detachable, it may be desirable to have all leaves 225 have pins 230 on both sides as this would allow all leaves 225 to be used on any mounting point 226. Pins 230, as shown in FIG. 24B, are socket cap screw (for example ¼-28 thread), having hexagonal recess 232 to accept an Allen wrench to facilitate installation. Pins 230 could also be a piece of aluminum welded or otherwise affixed on leaf 225 to serve the same purpose. Any means to locate support block 130 of bottle holder and valve assembly 120 in the correct location on leaves 225 is suitable. Pins 230 need not be present for leaves 225 to hold bottle holder and valve assembly 120, but leaf 225 having pins 230 is preferred. Leaf 225 also has end piece 235A, located at the other end of leaf 225 than that used to mount leaf 225 to mounting point 226. End piece 235A has hole 231 which engages with storage peg 227A. Leaf 225 can be placed on peg 227A when not installed on horizontal support 242.

FIG. 25 shows a perspective view of solid phase extraction system rack 250 used for holding SPE extraction system components during use. Rear legs 150A support horizontal member 252, shelf 227 and vacuum manifold 154. Front legs 150C support shelf 227. Horizontal member 252 is oriented in the same plane that passes through both rear legs 150A. Individual support leaf 225 is detachable and can be disengaged from mounting point 226 when not in use to facilitate access to disk holder 104 as is necessary to complete certain steps in a solid phase extraction procedure. Leaf 225A is shown in the detached position and may be placed on peg 227A for storage when not in use. Leaf 225B, shown attached to horizontal member 252, holds bottle holder and valve assembly 120 with support block 130 resting on two adjacent leaf 225B. Horizontal member 252 has two rows of mounting points 226. Lower mounting points 226A form a row and are below the row of mounting points formed by upper mounting points 226B.

The presence of mounting point 226 at more than one height allows the distance between leaf 225A and shelf 227 to change depending on whether lower mounting point 226A or upper mounting point 226B is chosen to mount leaf 225A. The differing mounting heights can facilitate the use of SPE media of different heights, such as SPE cartridges, or the use or non-use of Luer valve 114 in between fitting 58A and fitting 110 of disk holder 104. Shelf 227 has openings 228 into which fluid management block(s) 200 are installed and secured with threaded fasteners or by other means. The threaded fasteners pass through suitable holes in the interior walls of opening(s) 228 and into threaded mounting hole(s) 201 of Block 200.

In use, disk holder 104 is mounted on fitting 58A or Female Luer port 54 of valve 114. Bottle holder and valve assembly 120 is placed in between two adjacent leaves 225B which are mounted at the same level above shelf 227. Support block upper section 130A rests on the top surface of two adjacent leaf 225B and support block lower section 130B rests in between two adjacent leaves 225B. Sample delivery tube 136 of bottle holder and valve assembly 120 extends into cavity 112 of disk holder 104. Detachable support leaf 225 serves the same purpose as hinged leaf 224 but instead of being hinged they are detachable. Leaf 225A is shown as detached when not in use as to facilitate access to disk holder 104 as is necessary to complete certain steps in a solid phase extraction procedure. Detachable leaf(s) 225B may be detached after completion of the sample filtration step for the sample(s) using the bottle holder and valve assemblies 120 they are supporting. System rack 250 sits on work surface 146 which may be located in a fume hood due to the solvents typically employed in solid phase extraction procedures. Note that leaf 225B is offset to the right relative to square openings 228 on shelf 227. This is due to the asymmetry of fluid management block 200 with hole 78, into which bushing 202, fitting 58A and Luer valve 114 are installed, and on which disk holder 104 rests, are offset to the right.

System components could be manufactured and/or installed with an offset to the left if desired or with no offset if block 200 were manufactured with hole 78 centered in block 200. Vacuum manifold 154 is attached to rear legs 150A and located below shelf 227. Vacuum manifold has vacuum port(s) 156, with one vacuum port 156 for each block 200 that can be accommodated on rack 250. Vacuum port(s) 156 is attached to tubing 46B with a suitable fitting and supplies vacuum to fitting 30 and fitting 32 on fluid management block 200 through tubing 46B and attached fitting 214. Vacuum port(s) 156 may have a valve attached to provide individual control to each vacuum port 156 and this valve may be, but is not necessarily, a Luer valve. This valve may be located at any point in between port 156 and fitting 30 or fitting 32 on block 200. Vacuum manifold 154 also has vacuum port 158 which is connected to a waste-water container and vacuum source. Vacuum manifold 154 may also be equipped with a vacuum gauge to monitor vacuum. Rack 250 as shown can accommodate components for one to five sample extractions, being able to hold up to five block(s) 200 and up to five bottle holder and valve assembly 120. Rack 250 can be configured to accommodate components for any number of sample extractions.

FIG. 25A shows a cross section view of detachable support leaf 225 for use on system rack 250 as depicted in FIG. 25. Also shown is horizontal member 252 to which leaves 225 are attached by means of mounting point or mechanism 226. Leaf 225 may be constructed with a variety of materials or techniques. Leaf 225, as shown in FIG. 25A, is constructed of aluminum C-channel and base 229 is the upper horizontal surface of leaf 225. Leaf 225 has end piece 235 located at one end of leaf 225 to provide a surface on which a mechanism to engage with mounting point 226 is installed. End piece 235 also has hole 237 (for example with ¼-28 threads) to accept set screw 238 (for example with ¼-28 thread). Set screw 238, when installed in hole 237, can be adjusted to make leaf 225 level when installed on horizontal member 252.

Leveling leaf 225 allows leaf 225 to hold support 130 of bottle holder and valve assembly 120 in a horizontal orientation during the sample filtration step of an SPE procedure. Set screw 238 has hexagonal recess 239 which accepts an Allen wrench to facilitate installation and adjustment of set screw 238. Leaf 225 has pins 230, which may be, but are not necessarily, socket cap screws (for example with ¼-28 thread). In use, support block 130 sits in between two adjacent leaves 225 which must be installed on mounting points 226 located at the same level. Lower section 130B of support block 130 sits in between pins 230 with pins 230 positioning support block 130 of bottle holder and valve assembly 120 so that sample delivery tube 136 rests approximately in the center of cavity 112 of disk holder 104. Leaf 225, if not located at either end of horizontal member 252 will have pins 230 located on both sides of leaf 225 to facilitate the use of bottle holder and valve assembly 120 on either side of leaf 225.

In practice, as leaf 225 is detachable, it may be desirable to have all leaves 225 have pins 230 on both sides as this would allow all leaves 225 to be used on any mounting point 226. Pins 230, as shown in FIG. 25A, are socket cap screw (for example with ¼-28 thread), having hexagonal recess 232 to accept an Allen wrench to facilitate installation. Pins 230 could also be a piece of aluminum welded or otherwise affixed on leaf 225 to serve the same purpose. Any means to locate support block 130 of bottle holder and valve assembly 120 in the correct location on leaves 225 is suitable. Pins 230 need not be present for leaves 225 to hold bottle holder and valve assembly 120, but leaf 225 having pins 230 is preferred. Leaf 225 also has end piece 235A, located at the other end of leaf 225 than that used to mount leaf 225 to mounting point 226. End piece 235A has hole 231 which engages with storage peg 227A. Leaf 225 can be placed on peg 227A when not installed on horizontal support 252.

FIG. 26 Shows a perspective view of SPE cartridge 260 with flange 262, barrel 264 and Luer tip 44. FIG. 26A Shows a cross section of SPE cartridge 260 with flange 262, barrel 264, upper frit 266A, sorbent 268, lower frit 266B and Luer tip 44. Upper frit 266A and lower frit 266B are porous, have a pore diameter smaller than the diameter the particles of sorbent 268 and fit into barrel 264 with a friction fit. Sorbent 268 may be particles of polymer, modified or unmodified silica or activated carbon

FIG. 27 shows a perspective view of SPE system rack 270 used for holding SPE extraction system components during use. Rear legs 150A support horizontal member 272, shelf 227 and vacuum manifold 154. Front legs 150C support shelf 227. Horizontal member 272 is oriented in the same plane that passes through both rear legs 150A. Support fork 274 is detachable and can be disengaged from fork mounting point 276 when not in use to facilitate access to disk holder 104 as is necessary to complete certain steps in a solid phase extraction procedure. Fork(s) 274, shown attached to horizontal member 272, holds bottle holder and valve assembly 120 with support block 130 resting on two arms 275 of fork 274. Horizontal member 272, as shown in FIG. 27, has two rows of fork mounting points 276. The presence of fork mounting point 276 at more than one height allows the distance between fork 274 and shelf 227 to change depending on whether upper mounting point 276B or lower mounting point 276A is chosen to mount fork 274. The differing heights can facilitate the use of SPE media of different heights, such as SPE cartridge 260, or the use or non-use of Luer valve 114 in between fitting 58A of block 200 and fitting 110 of disk holder 104. Shelf 227 has openings 228 into which fluid management block(s) 200 are installed and secured with threaded fasteners or by other means. The threaded fasteners pass through suitable holes in the interior walls of opening(s) 228 and into threaded mounting hole(s) 201 of Block 200. In use, disk holder 104 is mounted on fitting 58A or Female Luer port 54 of valve 114. Bottle holder and valve assembly 120 is placed in between the two arms of fork 274. Support block upper section 130A rests on the top surface of the two arms of fork 274 and support block lower section 130B rests in between the two arms of fork 274.

Sample delivery tube 136 of bottle holder and valve assembly 120 extends into cavity 112 of disk holder 104. Detachable fork(s) 274 may be detached after completion of the sample filtration step for the sample(s) using the bottle holder and valve assemblies 120 they are supporting. System rack 270 sits on work surface 146 which may be located in a fume hood due to the solvents typically employed in solid phase extraction procedures. Note that fork(s) 274 are offset to the right relative to square openings 228 on shelf 227. This is due to the asymmetry of fluid management block 200 with hole 78, into which bushing 202, fitting 58A and Luer valve 114 are installed, and on which disk holder 104 rests, are offset to the right.

System components could be manufactured and/or installed with an offset to the left if desired or with no offset if block 200 were manufactured with hole 78 centered in block 200. Vacuum manifold 154 is attached to rear legs 150A and located below shelf 227. Vacuum manifold has vacuum port(s) 156, with one vacuum port 156 for each block 200 that can be accommodated on rack 270. Vacuum port(s) 156 is attached to tubing 46B with a suitable fitting and supplies vacuum to fitting 30 and fitting 32 on fluid management block 200 through tubing 46B and attached fitting 214. Vacuum port(s) 156 may have a valve attached to provide individual control to each vacuum port 156 and this valve may be, but is not necessarily, a Luer valve. This valve may be located at any point in between port 156 and fitting 30 or fitting 32 on block 200. Vacuum manifold 154 also has vacuum port 158 which is connected to a wastewater container and vacuum source. Vacuum manifold 154 may also be equipped with a vacuum gauge to monitor vacuum. Rack 270 as shown can accommodate components for one to five sample extractions, being able to hold up to five block(s) 200 and up to five bottle holder and valve assembly 120. Rack 270 can be configured to accommodate components for any number of sample extractions. Rack 270 as shown in FIG. 27 has detachable fork(s) 274. System rack 220 and system rack 240 could also be configured with detachable fork 274 or a hinged component having a fork with two arms similar to fork 274, to serve the same function of supporting block 130.

FIG. 27A shows a perspective view of fork 274 with arms 275 and end piece 235C. FIG. 27B shows a cross section view of detachable support fork 274 and associated parts for use on system rack 270 as depicted in FIG. 27. Also shown is horizontal member 272 to which fork(s) 274 are attached by means of mounting point or mechanism 276. Fork 274 may be constructed with a variety of materials or techniques. Fork 274, as shown in FIG. 27B, could be constructed of aluminum bar stock or other materials. Fork 274 has end piece 235C located at one end of fork 274 to provide a surface on which a mechanism to engage with mounting point 276 is installed. End piece 235 also has hole 237 with ¼-28 threads to accept ¼-28 thread set screw 238. Setscrew 238, when installed in hole 237, can be adjusted to make fork 274 level when installed on horizontal member 272.

Leveling fork 274 allows fork 274 to hold support 130 of bottle holder and valve assembly 120 in a horizontal orientation during the sample filtration step of an SPE procedure. Set screw 238 has hexagonal recess 239 which accepts an Allen wrench to facilitate installation and adjustment of set screw 238. Fork 274 has pins 230, which may be, but are not necessarily, socket cap screws (for example with ¼-28 thread). In use, support block 130 sits in between two arms 275 located on the same fork 274. Lower section 130B of support block 130 sits in between arms 275 with pins 230 positioning support block 130 of bottle holder and valve assembly 120 so that sample delivery tube 136 rests approximately in the center of cavity 112 of disk holder 104. Pins 230, as shown in FIG. 27B, are a socket cap screw (for example with ¼-28 thread), having hexagonal recess 232 to accept an Allen wrench to facilitate installation. Pins 230 could also be a piece of aluminum welded or otherwise affixed on fork 274 to serve the same purpose. Any means to locate support block 130 of bottle holder and valve assembly 120 in the correct location on fork 274 is suitable. Pins 230 need not be present for fork 274 to hold bottle holder and valve assembly 120, but fork 274 having pins 230 is preferred. System rack 270 is also shown with cartridge hole 278 along the rear edge of shelf 227 to the right of square hole 228. Cartridge hole 278 can hold SPE cartridge 260 when an SPE procedure specifies filtering the water sample through two SPE cartridges 260 in series or through SPE disk 100 followed by SPE cartridge 260 also in series. This setup is detailed in FIG. 27C. Storage peg 227A, located on shelf 227 of system rack 220 and system rack 250 could be provided on shelf 227 of system rack 270 to store fork 274 when not in use. Storage peg 242A, located on horizontal member 242 of system rack 240 could also be provided on horizontal member 272 of system rack 270. A variety of means could be provided to stow fork 274, leaf 225, leaf 245 or Individual upper shelf segment 143.

FIG. 27C shows a cross section view of block 200 and SPE cartridge 260 and associated parts used to pass a water sample undergoing extraction by an SPE procedure through two SPE cartridges 260 in series or to pass a water sample undergoing extraction by an SPE procedure through SPE disk 100 followed by SPE cartridge 260 also in series. Block 200 is shown in more detail in FIG. 22. Block 200 has Male Luer fitting 111, male Luer fitting 30, modified male Luer fitting 32 and 24-414 thread hole cap 88. The modifications to fitting 32 are shown in FIG. 2 and FIG. 3. Cartridge connecting tubing 279 has fitting 214 on both ends. Fitting 215 or fitting 58 would also be suitable on either end of connecting tubing 279. Adapter 261 fits into the open, flanged end of SPE cartridge 260. Adapter 261 has a male Luer such as fitting 30 to connect to fitting 214 and tubing 46B. In use tubing 46B is attached by way of port 156 on vacuum manifold 154 to a waste-water container and a source of vacuum.

In operation, the solid phase extraction system described may be used to extract liquid samples, for example, water samples, by an SPE procedure. The objective may be to obtain an extract of organic solvent containing selected trace chemicals that were originally present in the water sample. This extract is typically, but not necessarily, an organic solvent and may have a volume, after concentration procedures, of 1/50th to 1/2,000th the volume of the original water sample. The extract is then tested using a determinative technique to determine the concentration of various trace chemicals in the extract. This data can be used to calculate the concentration of these trace chemicals in the original water sample.

To perform an SPE extraction the following steps are taken. These steps are typically done with both block 70, block 200 and if using system rack 138, 140, 220, 240, 250, 270 or a system rack of similar design. The water sample to be extracted by SPE is typically collected in a glass bottle. Bottle holder and valve assembly 120 is attached directly to this sample bottle by means of the appropriate hole cap such as hole cap 122 (for example, for 33-430 thread bottles). Bottle holder and valve assembly 120 as depicted in FIG. 16, uses hole cap 122 with 33-430 thread, typically found on a 1,000 mL bottle. Other bottle threads can be accommodated such as 24-400 thread (250 mL bottle), 28-400 thread (500 mL bottle) and 33/400 thread (950 mL bottle) using different bottle holder and valve assembly 120 configurations for 24-400 and 28-400 thread and a 33-400 hole cap with described flange 124 and connecting tube 128. Sample bottles with thread diameters greater than a 33-430 cap can also be accommodated with a wider flange and connecting tube 128 by using a hole cap of the larger bottle thread or appropriate adapters.

The actual volume of the water sample undergoing the SPE procedure is also normally determined. This is often done by marking the meniscus on the bottle for later determination by refilling the bottle to the meniscus mark with reagent water after the SPE extraction is complete. The volume of reagent water needed to refill the sample bottle to the meniscus mark is then determined. The sample to be extracted by the SPE procedure may require pH adjustment or the addition of preservatives, dichlorinating agents or other chemicals depending on the specific SPE procedure being conducted. After performing any steps necessary to prepare the water sample for extraction by the SPE procedure, bottle holder and valve assembly 120 are attached to the sample bottle by means of the appropriate hole cap.

Next, porous member 102 is placed in recess 108 and SPE disk 100 is installed in recess 106 of disk holder 104. Other known disk holders can also be used provided they have an outlet with male Luer tip 44 to interface with Luer valve 114 or fitting 58A, and a sufficient reservoir above disk 100 to contain the water sample delivered by sample delivery tube 136. SPE cartridge 260 could also be used in place of disk holder 104 and SPE disk 100 if a suitable reservoir were attached to flange 262.

If using system rack 138 or 140 the following steps are taken after completing the assembly of disk holder 104 and attaching bottle holder and valve assembly 120 to the sample bottle.

Block 70, with all the fittings and parts shown in FIG. 14 is placed in square hole 148 in lower shelf 144 of system rack 138 or system rack 140. Block 70 may be secured in shelf 144 by threaded fasteners or by other means. System rack 138 or 140 may accommodate three to eight blocks 70 although lower or higher numbers of blocks 70 are possible. System rack 138 or 140 will generally have provision for the same number of bottle holder and valve assembly(s) 120 as block(s) 70. Male×female Luer valve 114 may be, and is preferentially, installed on fitting 58A by attaching male Luer port 44 of Luer valve 114 to fitting 58A. Male Luer port 44 of fitting 110, installed in hole 80 of disk holder 104, is placed on female Luer port 54 of Luer valve 114. The handle on Luer valve 114 may be oriented towards the right front edge of block 70 (as viewed in FIG. 14) to allow for ease of operation.

Next, a vial or bottle with 24-414 or 24-410 thread may be installed in recess 76 or hole cap 88 of block 70. Then fitting 58B with attached tubing 46B may be attached to fitting 30 as shown in FIG. 14. Tubing 46B may also be connected to port 156 on vacuum manifold 154. Port 158 on vacuum manifold 154 is connected by suitable tubing to a waste-water container and a source of vacuum.

Next, ball valve 132 may be moved in the closed position and bottle holder and valve assembly 120 may be inverted with attached sample bottle. Then bottle holder and valve assembly 120 are placed, with attached sample bottle, in square hole 148 of upper shelf 142 of system rack 138 or in square hole 148 of individual upper shelf segment 143 of system rack 140. Cutout 152 as shown in FIG. 19 and FIG. 20 allows the section of connecting tube 128 that is below block 130 to pass through cutout 152 when placing block 130 in square hole 148. This avoids having to pass sample delivery tube 136, ball valve 132 and the lower section of connecting tube 128 through square hole 148 in order for block 130 to rest in hole 148. This is especially advantageous if system rack 138 or system rack 140 is located in a fume hood. Upper shelf 142 or individual upper shelf segment 143 should be positioned so the center of square hole 148 is located over the center of disk holder 104 and sample delivery tube 136 is centered in cavity 112 of disk holder 104. Connecting tube 128 should be adjusted up or down on support block 130 so the end of sample delivery tube 136 is about 7 mm above SPE disk 100. A means to adjust the height of upper shelf 142 over lower shelf 144 in system rack 138 and a means to adjust the height of horizontal support 141 over lower shelf 144 in system rack 140 may also be provided.

It is often desirable to wash SPE disk 100 with solvent prior to use to remove interfering compounds which may be present such as phthalate plasticizers. Some types of SPE disk 100 also require conditioning with a polar solvent such as methyl alcohol before use. If SPE disk 100 washing or conditioning is required, the appropriate wash or conditioning solvents are introduced into disk holder 104. Luer valve 114 is operated to transfer, under vacuum, the solvents from disk holder 104 to the vial or bottle, such as vial 94 (for example having 40 mL volume and 24-414 thread), installed in recess 76 or hole cap 88 of block 70. If conditioning is required SPE disk 100 should remain immersed and not be exposed to air until filtration of the water sample is complete. Note that 30 mL and 60 mL vials with 24-414 thread and 125 mL bottles with 24-410 thread are also available. The vacuum may be controlled by Luer valve 114 installed under disk holder 104 or by other means. The volume of the vial or bottle used is based on the anticipated volume of the wash solvents or conditioning solvents. The specific wash or conditioning solvents, the volume of solvent used and the order the solvents (which may include water) are introduced is typically specified in the SPE extraction procedure.

After any wash or conditioning steps are complete close Luer valve 114 under disk holder 104. Optionally, the vacuum may be turned off. A second valve installed on port(s) 156 or port 158 of vacuum manifold 154 is a convenient means for controlling vacuum but is not required.

Next, the vial installed in recess 76 or hole cap 88 of block 70 may be removed. Rinse and conditioning solvents contained in the vial are generally disposed. The vial may be rinsed with solvent for later use in collecting the extract. As a next step, fitting 58B with attached tubing 46B may be detached from fitting 30, and fitting 58B installed on fitting 34 as shown in FIG. 14. The system is now configured to filter the water sample. Next, ball valve 132 on bottle holder and valve assembly 120 may be opened. Water should enter disk holder 104 from the sample bottle and the disk holder 104 may be at about halfway. Water leaving the inverted sample bottle creates a vacuum sufficient to stop any additional water from leaving the sample bottle. Next, Luer valve 114 may be opened under disk holder 104 or otherwise a vacuum applied. Water will begin to flow through SPE disk 100 and out of disk holder 104 passing through porous member 102, fitting 110, Luer valve 114, through block 70 and tubing 46B to a wastewater container. This will cause the water level in disk holder 104 to drop. When the lower end of sample delivery tube 136 is exposed, air will travel up passageway 126 of bottle holder and valve assembly 120 into the sample bottle. This will reduce the vacuum in the sample bottle and water will exit the sample bottle into disk holder 104. This will immerse the lower opening of sample delivery tube 136 (without overflowing disk holder 104) preventing more air from entering the sample bottle and allowing the reestablishment of the vacuum in the sample bottle. This reestablished vacuum in the sample bottle will stop additional water from leaving the sample bottle until the lower end of sample delivery tube 136 is again exposed allowing air to enter the sample bottle. This process will repeat until the water sample bottle is empty with the trace chemicals present in the water sample being retained on SPE disk 100.

After filtration of the water sample is complete air or an inert gas may be passed through SPE disk 100 to remove residual water from SPE disk 100. Next, Luer valve 114 under disk holder 104 is closed and fitting 58B is removed from fitting 34. Install fitting 58B on fitting 30 and install a vial in recess 76 or hole cap 88 of block 70. The objective of the next step is to elute the trace chemicals captured by SPE disk 100 from the water sample off of SPE disk 100, transferring these trace chemicals from SPE disk 100 into a small volume of organic solvent.

These solvents are termed elution solvents. A polar elution solvent should be used first as a non-polar solvent, being immiscible with water, may fail to pass through water saturated SPE disk 100, even when vacuum or positive pressure is applied. Some SPE procedures require that the sample bottle first be rinsed with the elution solvent(s) before the solvent is transferred to disk holder 104. This polar organic elution solvent is added to disk holder 104 in a quantity sufficient to cover and saturate SPE disk 100. A typical 47 mm SPE disk using disk holder 104 might require 7 mL of solvent. Additional solvent may be required if the water sample contained sediment or debris. After allowing the elution solvent to soak SPE disk 100 for a specified time, open Luer valve 114 under disk holder 104, or otherwise apply vacuum, and collect the polar elution solvent in the vial installed in recess 76 or hole cap 88 of block 70. This step is usually repeated with a non-polar solvent with the specific SPE procedure being employed determining the solvents chosen and the number of elution steps performed.

If using system rack 220, the steps of the SPE procedure detailed above for system rack 138 and system rack 140 apply. The mounting of fluid management block 200 in system rack 200 differs from the mounting of fluid management block 70 in system rack 138 and system rack 140. The specifics for mounting bottle holder and valve assembly 120 on system rack 220 also differ from the specifics for mounting bottle holder and valve assembly 120 on system rack 138 and system rack 140. System rack 220 has horizontal member 222 oriented in the same plane as the plane that passes through rear legs 150A. Horizontal member 222 may be permanently mounted to legs 150A or may be adjustable in height above shelf 227. Adjusting the height of horizontal member 222 can allow for the use of different SPE consumables, such as SPE cartridge 260 or other disposable SPE consumables, or prior art SPE disk holders that have different heights while maintaining the correct clearance between the lower end of sample delivery tube 136 and the upper surface of SPE disk 100. The clearance between the lower end of sample delivery tube 136 and the upper surface of SPE disk 100 (or other SPE consumable) can also be adjusted by moving support block 130 up or down connecting tube 128.

FIG. 23 depicts system rack 220 with hinged support leaf 224 and detachable support leaf 225. In practice, system rack 220 would typically have either hinged support leaf 224 or detachable support leaf 225 in all positions. Hinged support leaf 224 can be folded up when not needed to support block 130 of bottle holder and valve assembly 120. Detachable support leaf 225 can be removed when not needed to support block 130 of bottle holder and valve assembly 120. Detachable support leaf 225 may be placed on storage peg 227A when not installed on horizontal support 222. Mounting point 226 serves as an attachment point for detachable leaf 225. Fluid management block 200 fits into opening 228, which is shown as, but is not necessarily, square or rectangular. Fluid management block 200 may be, but is not necessarily, secured with threaded fasteners.

If using system rack 240, the steps of the SPE procedure detailed above for system rack 138 and system rack 140 apply. The use and construction of system rack 240 is similar to that of system rack 220. The primary difference being horizontal member 242 is oriented in a plane at a right angle to the plane that passes through rear legs 150A and extends forward to middle legs 150B. As a consequence of this the rear part of larger width upper section 130A of block 130 rests directly on horizontal member 242 with hinged support leaf 244A or detachable support leaf 245A supporting the middle and front part of larger width upper section 130A of block 130. Leaves 244 and 245 also differ from leaves 224 and 225 in that leaves 244 and 245 have a single pin 230 which sits in front of narrower width lower section 130B of block 130.

Leaves 224 and 225 have two pins 230 with narrower width lower section 130B of block 130 sitting in between the two pins 230. Peg 242A is shown in FIG. 24 as being located on horizontal member 242. It serves the same function as peg 227A located on shelf 227. Any of the rack systems described in this provisional patent application could have either peg 227A located on shelf 227 or peg 242A located on any of the horizontal members depicted in FIG. 23, FIG. 24, FIG. 25 or FIG. 27. Also, a peg, or cylindrical structure is shown but a variety of means or methods could be employed provide for the storage of leaf 225, leaf 245 or fork 274, in addition to peg 227A or peg 242A. Similar means or methods could also be employed to provide for the storage of individual upper shelf segment 143 on system rack 140 as shown in FIG. 18.

If using system rack 250, the steps of the SPE procedure detailed above for system rack 138 and system rack 140 apply. The use and construction of system rack 250 is similar to that of system rack 220. The primary difference being horizontal member 252 has attachment points 226 at two (or more) different levels. This serves to allow detachable leaf 225 to be installed at different heights above shelf 227. This allows bottle holder and valve assembly 120 to have differing heights above shelf 227 and block 200. This facilitates the maintenance of the proper clearance between the lower end of sample delivery tube 136 and the upper surface of SPE disk 100 as described above. This can allow for the use of different SPE consumables, such as SPE cartridge 260 or prior art SPE disk holders that have different heights or the use of SPE disk(s) 100 of differing thicknesses. Horizontal member 252 could be at a fixed height above shelf 227 or be adjustable in height.

If using system rack 270, the steps of the SPE procedure detailed above for system rack 138 and system rack 140 apply. The use and construction of system rack 270 is similar to that of system rack 250. The primary difference being support fork(s) 274 is used in place of support leaves 225. Two adjacent leaves 225 are required to hold block 130 of bottle holder and valve assembly 120 in system rack 220 and system rack 250. In system rack 270 the two arms of a single support fork 274 hold block 130 of bottle holder and valve assembly 120. Horizontal member 272 could be at a fixed height above shelf 227 or be adjustable in height above shelf 227. Rack 270 is shown with mounting points 276 at two heights above shelf 227. System rack 270 could have mounting point(s) 276 at a single height above shelf 227 or at two or more heights above shelf 227.

System rack 270 is also shown in FIG. 27 with optional cartridge hole 278 along the rear edge of shelf 227 to the right of square hole 228. Cartridge hole 278 can hold SPE cartridge 260 when an SPE procedure specifies filtering the water sample through two SPE cartridges 260 in series or through SPE disk 100 followed by SPE cartridge 260 also in series. This setup is detailed in FIG. 27C. Cartridge hole 278 is wider than SPE cartridge barrel 264 but narrower than SPE cartridge flange 262 allowing SPE cartridge 260 to be inserted into cartridge hole 278 and supported by shelf 227.

In use, the water sample undergoing extraction by an SPE procedure that specifies filtering the water sample through two SPE cartridges 260 in series or through SPE disk 100 followed by SPE cartridge 260 also in series would pass from the sample bottle, through bottle holder and valve assembly 120, into cavity 112 of disk holder 104 and through SPE disk 100. The water sample would then pass through tubing 46A (and associated fittings) of block 200 and into cartridge connecting tubing 279. Next, the water sample would then enter male Luer tip 44 at the bottom of SPE cartridge 260 as shown in FIG. 27C. After passing through sorbent 268 it would exit SPE cartridge 260 through adapter 261 and be conveyed to the waste-water container by tubing 46B, manifold 154 and associated parts.

Some prior art SPE disk holder designs feature a mechanism to clamp down on the edge of SPE disk 100 to secure it in place. This prevents the water sample from flowing through the outside edge of the SPE disk held under this clamping mechanism and can effectively reduce the usable surface area of SPE disk 100 by 25%. Some of these prior art disk holders are compatible with the SPE extraction system described in this provisional patent application. If 25% of a 47 mm SPE disk's surface is covered by this prior art disk holder clamping mechanism 5 mL of solvent should be sufficient for an elution step. There are also disposable consumables that have a plastic housing holding sorbent material that functions as an SPE disk. These disposable consumables may also be compatible with this SPE extraction system provided they have male Luer tip 44 as an outlet and a sufficient reservoir that can function in the same way as cavity 122 of disk holder 104. Support block 130 on bottle holder and valve assembly 120 can be adjusted up or down connecting tube 128 to allow for consumables or prior art disk holders that have differing heights, maintaining a clearance (e.g., an approximate 7 mm clearance) below the lower end of sample delivery tube 136 and the upper surface of SPE disk 100.

A solvent extract obtained from this SPE extraction system normally undergoes a procedure to remove residual water in the extract. This water is the water that remained in SPE disk 100 when the polar elution solvent was added to disk holder 104. The extract may be dried by passing it through an anhydrous salt such as sodium sulfate or through a phase separation membrane. Fluid management block 70 or block 200 may be used to facilitate extract drying. A syringe barrel of suitable volume with a frit in the bottom can be used to hold sodium sulfate. The male Luer tip of the syringe barrel being installed directly on female Luer port 54 of Luer valve 114, located on fitting 58A. The solvent extract to be dried is poured into the syringe barrel with sodium sulfate, Luer valve 114 is opened, and the dried extract collected in a 24-414 vial installed in recess 76 or hole cap 88 of block 70 or block 200. Any phase separation membrane drying system with a male Luer outlet can be similarly used.

Male Luer fittings such as fitting 30, modified to allow ⅛″ outside diameter tubing 46 to pass through enlarged passageway 33 of male Luer tip 44 may or may not have tubing 46 fit with a friction fit through passageway 33. Examples of such modified male Luer fitting include, but are not limited to, fitting 32 and fitting 34. Male Luer fittings such as fitting 48, modified to allow ⅛″ outside diameter tubing 46 to pass through enlarged passageway 51 of male Luer tip 44 may or may not have tubing 46 fit with a friction fit through passageway 51. Examples of such modified male Luer fitting include, but are not limited to, fitting 50. ⅛″ outside diameter tubing 46 could be replaced with 3 mm outside diameter tubing or another diameter that would fit through male Luer port 44 with or without the described modifications to male Luer tip 44 shown in FIG. 2 or FIG. 7.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, the term “about” and “approximately” generally mean plus or minus 10% of the value stated, e.g., about 250 μm would include 225 μm to 275 μm, about 1,000 μm would include 900 μm to 1,100 μm.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified, and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

What is claimed is:

1. A Luer lock, comprising:
a tapered female member;
a tapered male member defining a passage; and
a tubing inserted through the passage, the tubing defining an outer cross-section corresponding to an inner cross-section of the passage,
wherein the tapered male member is configured to be inserted into the tapered female member such that the tube is in fluid communication with the tapered female member and the tubing exerts a compressive force at a mating surface between the tapered male member and the tapered female member to increase friction therebetween and inhibit leakage.

2. The Luer lock of claim 1, wherein male member defines a side port defined on a side wall thereof, the side port providing an additional fluid pathway for application of vacuum or external pressure.

3. The Luer lock of claim 1, wherein the male member and the female member have an equal taper angle in the range of 1° to 10°.

4. The Luer lock of claim 1, wherein the at least one of the female member or the male member includes threads for coupling the female member to the male member.

5. The Luer lock of claim 1, wherein neither the male member nor the female member includes threads to couple the female member to the male member.

6. The Luer lock of claim 1, wherein the tubing extends beyond the passage of the tapered male member into a cavity of the female member.

7. A Luer lock, comprising:
a tapered female member;
a tapered male member defining a central axis and a passage along a central axis;
a side port defined through a sidewall of the tapered male member, the side port defining a lateral passage; and
a tubing inserted through the passage along the central axis, the tubing defining an outer cross-section corresponding to an inner cross-section of the passage,
wherein the tapered male member is configured to be inserted into the tapered female member such that the tube is in fluid communication with the tapered female member.

8. The Luer lock of claim 7, wherein the insertion of tubing into the tapered male member exerts a compressive force at a mating surface between the tapered male member and the tapered female member to increase friction therebetween and inhibit leakage.

9. The Luer lock of claim 7, wherein the side port provides an additional fluid pathway for application of vacuum or external pressure.

10. The Luer lock of claim 7, wherein the male and the female member have an equal taper angle in the range of 1° to 10°.

11. The Luer lock of claim 7, wherein the at least one of the female member or the male member includes threads for coupling the female member to the male member.

12. The Luer lock of claim 7 wherein neither the male member not the female member includes threads to couple the female member to the male member.

13. The Luer lock of claim 7, wherein the tubing extends beyond the passage of the tapered male member into a cavity of the female member.

14. A disk holder for Solid Phase Extraction (SPE), comprising:
a cylindrical cavity with a closed bottom including an angled section, a first recess having a first diameter and a first thickness, a second recess defining a second diameter and a second thickness and an opening;
a SPE disk and a porous member disposed in the cavity; and
a male Luer fitting installed in the opening,
wherein the porous member has a diameter equal to the second diameter and a thickness equal to the second thickness,
wherein the SPE disk has a diameter that corresponds to the first diameter.

15. The disk holder of claim 14, wherein the angled section is structured to provide a clearance for installation of the SPE disk and limits the volume of organic solvent necessary for wash and elution steps of the SPE procedure by narrowing the bottom of the cavity.

16. The disk holder of claim 14, wherein the male Luer fitting is configured to couple the disk holder to a SPE system and allow application of a vacuum to the second recess.

17. The disk holder of claim 14, wherein the Luer valve is configured to control flow of liquids and gases through the SPE disk.

18. The disk holder of claim 14, wherein the SPE disk includes at least one of a glass fiber or PTFE, containing a sorbent uniformly distributed across an entire cross-section of the SPE disk.

19. The disk holder of claim 18, wherein the SPE disk further includes a layer of glass fiber containing no sorbent.

20. The disk holder of claim 14, wherein the thickness of the SPE disk is equal to or less than 0.4 mm.
